(19) United States
(12) Patent Application Publication
(10) Pub. No.: US 2025/0164698 A1
(43) Pub. Date: May 22, 2025

(54) ADJUSTABLE ANGLE ASSEMBLY FOR PROVIDING A TRANSITION FROM A CABLE TO A CONNECTOR

(71) Applicant: Eaton Intelligent Power Limited, Dublin 4 (IE)

(72) Inventors: Oliver Gordon Fletcher, Clonmel (IE); Mathew Peter Lewis, Summerville, SC (US); Claudia Flores, La Puente, CA (US); Christian Alonso Robles Sabas, Chino Hills, CA (US); Jameson Mora, Paso Robles, CA (US)

(21) Appl. No.: 18/949,701

(22) Filed: Nov. 15, 2024

Related U.S. Application Data
(60) Provisional application No. 63/572,084, filed on Mar. 29, 2024.
(60) Provisional application No. 63/600,399, filed on Nov. 17, 2023.

(51) Int. Cl. G02B 6/36; G02B 6/44; H01R 13/58

(52) U.S. Cl. CPC G02B 6/3604; G02B 6/4478; G02B 6/44785; H01R 13/582

(57) ABSTRACT

An assembly adjustable to different angular positions for transitioning cable structures (e.g., wires, optical fibers) of a cable to a connector.

### CROSS-REFERENCE TO RELATED APPLICATIONS

This application claims benefit to U.S. Provisional Application No. 63/572,084 filed on 11 Mar. 29, 2024, and U.S. Provisional Application No. 63/600,399 filed on Nov. 17, 2023, which are hereby incorporated by reference.

### TECHNICAL FIELD

The invention relates to the technical field of assemblies for guiding and protecting cable structures such as wires.

### BACKGROUND

Backshell assemblies provide a transition between a cable and an electrical connector. Strain relief backshell assemblies in particular provide a clamping force on the wire bundle of the cable to prevent damage to the termination of the wires at the electrical connector. Various configurations of the backshell assemblies are known. For example, 0°, 45° and 90° configurations of backshell assemblies are known in which the configurations are defined by the angle between the cable and the backshell assembly. Some examples of backshell assemblies for guiding wires are disclosed in patents: U.S. Pat. Nos. 9,444,180, 9,780,483, US20190190190, U.S. Pat. No. 5,380,219,CN211958088, CN211670377, US20120133750, U.S. Pat. Nos. 6,419,519, 8,313,340, 7,544,085, 7,862,369, 8,435,066, 9,627,800 and KR1020120126899.

### SUMMARY

One aspect of the present disclosure relates to a device for receiving one or more cable structures (e.g., electrical wires, optical fibers) adapted for conveying data signals and/or power. In one example, the device is a backshell for providing an angularly adjustable transition from a cable to connector. The device includes an assembly having a first end and a second end. The assembly defines a passage that extends through assembly from the first end to the second end, where the first end defines a first end axis, and the second end defines a second end axis. The passage is configured for receiving the one or more cable structures. The assembly can be pivotally adjustable about a pivot axis to adjust an angle which is defined between the first end axis and the second end axis. The assembly includes a first body which defines the first end of the assembly, and the first body includes a ball through which the passage extends. The first body may further include a first passage-defining portion that extends along the first end axis from the ball to the first end of the assembly. The assembly includes a second body defining the second end of the assembly. The second body includes a socket structure that mounts over the ball of the first body and the second body also includes a second passage-defining portion that extends along the second end axis from the socket to the second end of the assembly. The socket structure and the ball define a pivot interface when the socket structure is mounted over the ball. The pivot interface may be adapted to allow relative pivotal movement between the first and second bodies about the pivot axis for allowing adjustment of the angle defined between the first and second end axes of the assembly. The second body further defines a socket expansion slot that extends through a portion of the second passage-defining portion of the second body, where the socket expansion slot is configured to allow the socket structure to be expanded. An angular retention arrangement is included within the assembly and the angular retention arrangement is defined between the ball and the socket structure. The angular retention arrangement allows the assembly to be set at a plurality of different angular positions. The angle defined between the first and second end axes of the assembly is different at each angular position of the assembly. The assembly further includes a locking mechanism for setting the assembly in a locked state in which expansion of the socket structure is limited such that the assembly is locked in a selected one of the angular positions. When the assembly is not in the locked state the angular position of the assembly can be adjusted about the pivot axis.

Another aspect of the present disclosure is a backshell device for connection to a connector to provide strain relief and bend control of a cable connected to the connector. The backshell device may comprising a pivotal backshell assembly having a first end and a second end. The first end is configured to connect to the connector and the second end is configured to accommodate the cable. The first end being defined by a backshell body, and the second end being defined by a cable management structure. The backshell body and cable management structure are pivotally moveable about a pivot axis relative to each other between a plurality of different angular positions. The pivotal backshell assembly also includes an angular retention arrangement for allowing the pivotal backshell assembly to be set at a selected one of the different angular positions. The angular retention arrangement includes at least one projection and a plurality of receptacles. The plurality of receptacles being positioned about the pivot axis and the at least one projection being received in different ones of the receptacles to vary the angular position of the pivotal backshell assembly. The angular retention arrangement being resiliently movable in an orientation along the pivot axis between a first state in which the angular position of the pivotal backshell assembly is adjustable and a second state in which the at least one projection is received within a corresponding one of the receptacles to lock the pivotal backshell assembly in a selected one of the angular positions. The backshell body and the cable management structure include a mating pivot guide arrangement for guiding pivotal movement of the pivotal backshell assembly movement about the pivot axis. The pivot guide arrangement being unitarily integrated with the backshell body and the cable management structure.

Another aspect of the present disclosure is a backshell device for a connection to a connector to provide strain relief and bend control of a cable connected to the connector. The backshell device includes a pivotal backshell assembly having a first end and a second end. The first end being configured for connection to the connector and the second end being configured to accommodate the cable. The first end being defined by a backshell body, and the second end being defined by a cable management structure. The backshell body and cable management structure being pivotally moveable about a pivot axis relative to each other between a plurality of different angular positions. The pivotal backshell assembly including an angular retention arrangement for allowing the pivotal backshell assembly to be set at a selected one of the different angular positions. The angular retention arrangement including a first set of openings defined by the backshell body about the pivot axis and a second set of openings defined by the cable management structure about the pivot axis. The openings of the first and second sets of openings aligning with each other when the pivotal backshell assembly is in the different angular positions. A locking hub including a plurality of pins that extend through the aligned sets of first and second openings to lock the pivotal backshell assembly in a selected angular position, the locking hub being held within the openings by a snap-fit connection.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a perspective view of the assembly;

FIG. 2 is an exploded view of the assembly of FIG. 1;

FIG. 3 is a top perspective view of the assembly of FIG. 1 in a in-line position;

FIG. 4 is a bottom perspective view of the assembly of FIG. 1;

FIG. 5 is a perspective view of the assembly of FIG. 1 in a right-angle position;

FIG. 6 is a perspective view of the assembly of FIG. 1 in an intermediate position;

FIG. 7 is a side view of the assembly of FIG. 1 in the intermediate position;

FIG. 8 is a side perspective view of the first body of FIG. 1;

FIG. 9 is a side view of a first body of the embodiment of FIG. 1;

FIG. 10 is a side view of a second body of the embodiment of FIG. 1;

FIG. 11 is a cross sectional view of a second body of the embodiment of FIG. 1;

FIG. 12 is a cross sectional view of the embodiment of FIG. 1;

FIG. 13 is a top perspective view of the assembly with a 180-degree range of rotation;

FIG. 14 is a bottom perspective view of the assembly of FIG. 13;

FIG. 15 is a cross sectional view of the embodiment of FIG. 13;

FIG. 16 is a side view of a first body of the embodiment of FIG. 13;

FIG. 17 is a top view of a first body of the embodiment of FIG. 13;

FIG. 18 is a side view of a second body of the embodiment of FIG. 13;

FIG. 19 is a top view of a second body of the embodiment of FIG. 13;

FIG. 20 is a cross sectional view of a second body of the embodiment of FIG. 13;

FIG. 21 is a top perspective view of the assembly with a 135-degree range of rotation;

FIG. 22 is a cross sectional view of the embodiment of FIG. 21;

FIG. 23 is a side view of a first body of the embodiment of FIG. 21;

FIG. 24 is a top view of a first body of the embodiment of FIG. 21;

FIG. 25 is a side view of a second body of the embodiment of FIG. 21;

FIG. 26 is a top view of a second body of the embodiment of FIG. 21;

FIG. 27 is a cross sectional view of a second body of the embodiment of FIG. 21;

FIG. 28 is a perspective view of an alternate embodiment;

FIG. 29 is a cross-sectional view of the embodiment of FIG. 28;

FIG. 30 is an exploded view of the embodiment of FIG. 28;

FIG. 31 is a side view of a first body of the embodiment of FIG. 28;

FIG. 32 is a top view of a first body of the embodiment of FIG. 28;

FIG. 33 is a side view of a second body of the embodiment of FIG. 28;

FIG. 34 is a front view of a second body of the embodiment of FIG. 28;

FIG. 35 is a cross sectional view of a second body of the embodiment of FIG. 28;

FIG. 36 is a perspective view of inserts of the embodiment FIG. 28

FIG. 37 is a perspective view of an alternate embodiment for constricting devices;

FIG. 38 is an exploded of the embodiment of FIG. 37;

FIG. 39 is a side view of a second body of the embodiment of FIG. 37;

FIG. 40 is a cross-sectional view of the embodiment of FIG. 37;

FIG. 41 is a perspective view of an alternate embodiment of the constriction device;

FIG. 42 is a second perspective view of the alternate embodiment if FIG. 41;

FIG. 43 is a top view of the assembly of FIG. 41;

FIG. 44 is a bottom view of the assembly of FIG. 41;

FIG. 45 is a perspective view of an alternate embodiment for constricting devices;

FIG. 46 is a second perspective view of the alternate embodiment of FIG. 45;

FIG. 47 is a bottom perspective view of the embodiment of FIG. 45;

FIG. 48 is a top view of the embodiment of FIG. 45;

FIG. 49 is a bottom view of the embodiment of FIG. 45;

FIG. 50 is a side view of the first body for an alternate embodiment of the retention arrangement;

FIG. 51 is a cross-sectional view of the second body of the embodiment of FIG. 50;

FIG. 52 is a perspective view of an alternate embodiment for constricting devices;

FIG. 53 is a side view of the second body of the embodiment of FIG. 52;

FIG. 54 is a perspective view of a locking band for the embodiment of FIG. 52;

FIG. 55 is a side view of the locking band for the embodiment of FIG. 52.

FIG. 56 illustrates another embodiment of a pivotable backshell of the present disclosure.

FIG. 57 is a top view of the embodiment of FIG. 56.

FIG. 58 is an exploded view of the embodiment of FIG. 56.

FIG. 59 is a side view the embodiment of FIG. 56.

FIG. 60 shows a further alternative embodiment of a pivotable backshell of the present disclosure.

FIG. 61 is a top view of the embodiment of FIG. 60.

FIG. 62 is an exploded view of the embodiment of FIG. 60.

FIG. 63 is an exploded top view of the embodiment of FIG. 60.

FIG. 64 is another alternate embodiment of a pivotable backshell of the present disclosure.

FIG. 65 is an exploded view of the embodiment of FIG. 64.

FIG. 66 is a further alternate embodiment of a pivotable backshell of the present disclosure.

FIG. 67 is a top view of the embodiment of FIG. 66.

FIG. 68 is an exploded top view of the embodiment of FIG. 66.

FIG. 69 is an exploded perspective view of the embodiment of FIG. 66.

FIG. 70 is a further alternate embodiment of a pivotable backshell of the present disclosure.

FIG. 71 is a top view of the embodiment of FIG. 70.

FIG. 72 is an exploded top view of the embodiment of FIG. 70.

FIG. 73 is an exploded perspective view of the embodiment of FIG. 70.

FIG. 74 is another alternate embodiment of a pivotable backshell of the present disclosure.

FIG. 75 is a top view of the embodiment of FIG. 74.

FIG. 76 is an exploded top view of the embodiment of FIG. 74.

FIG. 77 is an exploded perspective view of the embodiment of FIG. 74.

### DETAILED DESCRIPTION

Aspects of the present disclosure relate to an assembly having an adjustable construction for providing a transition between a cable and a connector. In some instances, the device may be a backshell for guiding cable structures (e.g., electrical wires, optical fibers) through the transition. In certain examples, the assembly includes first second and third parts, where the first and second parts are pivotably joined to allow multiple angular positions. In some examples, the positions can be a coaxial alignment (e.g., in-line, 180 degrees with zero angular offset) of the first and second parts. In some examples, the position may be a position where the first and second parts are positioned at an angle of 90 degrees from each other. In other examples, the first and second parts are angled at intermediate positions or at other angular positions. The third part may constrict on the second part to constrict the second part onto the first part, and thereby locking the assembly in a desired position. In certain examples, the assembly allows the angular position of between the first and second parts to be robustly locked in place through constriction provided by the third part while concurrently allowing the angular position to be adjusted without removing/detaching the first part from the second part by simply loosening the constriction of the third part.

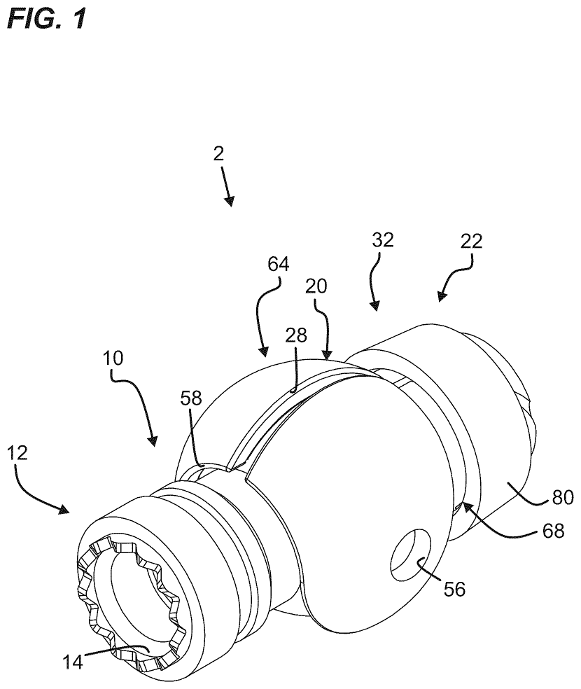

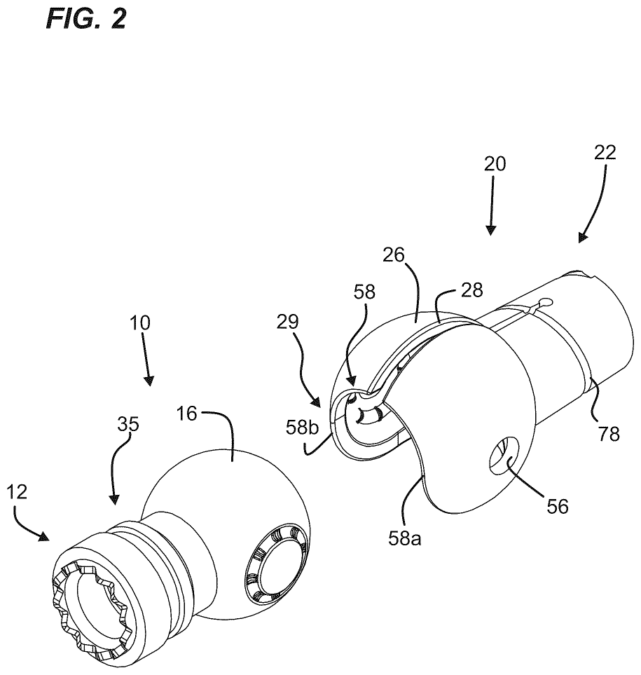

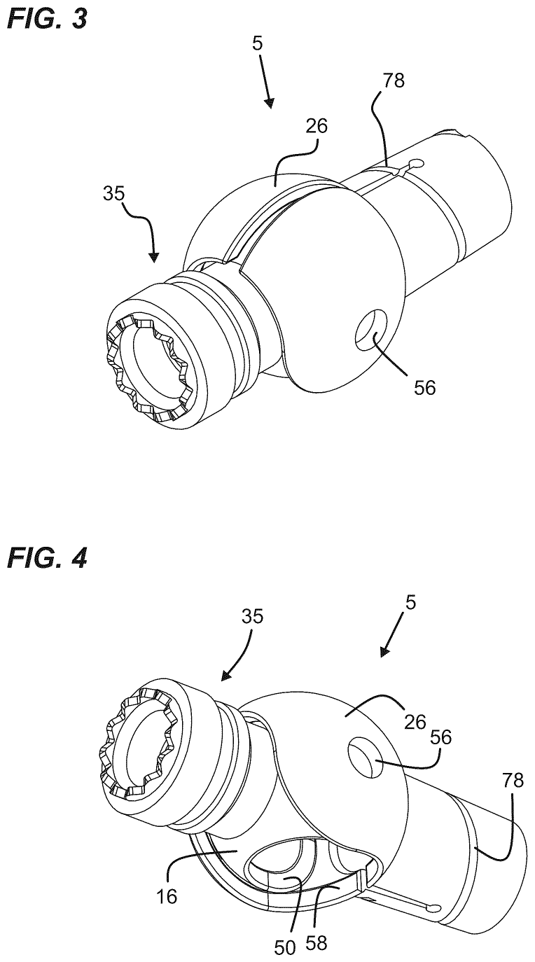

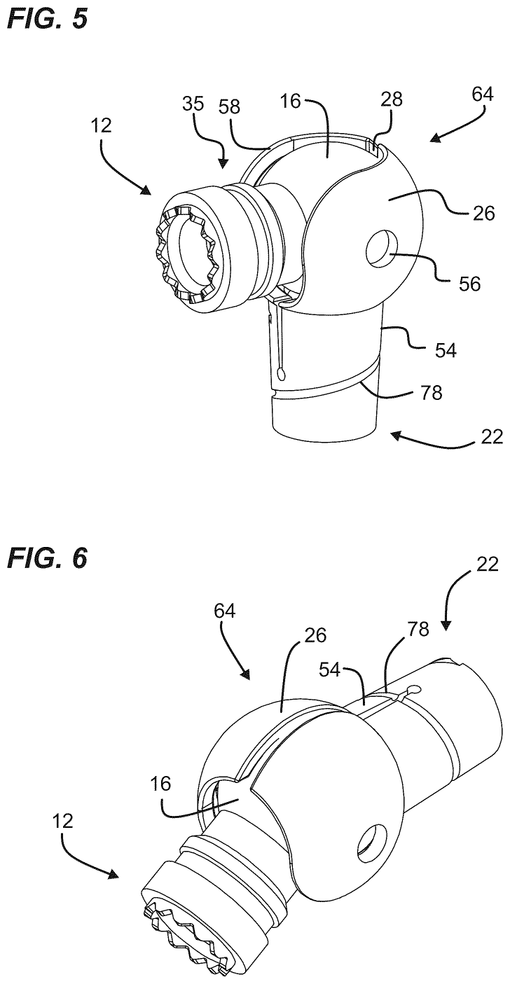

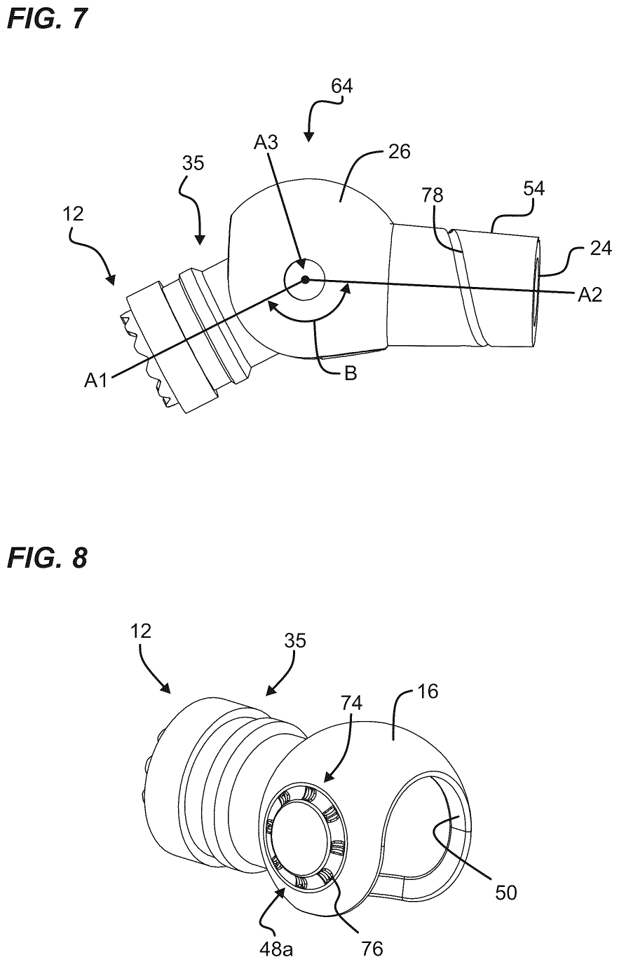

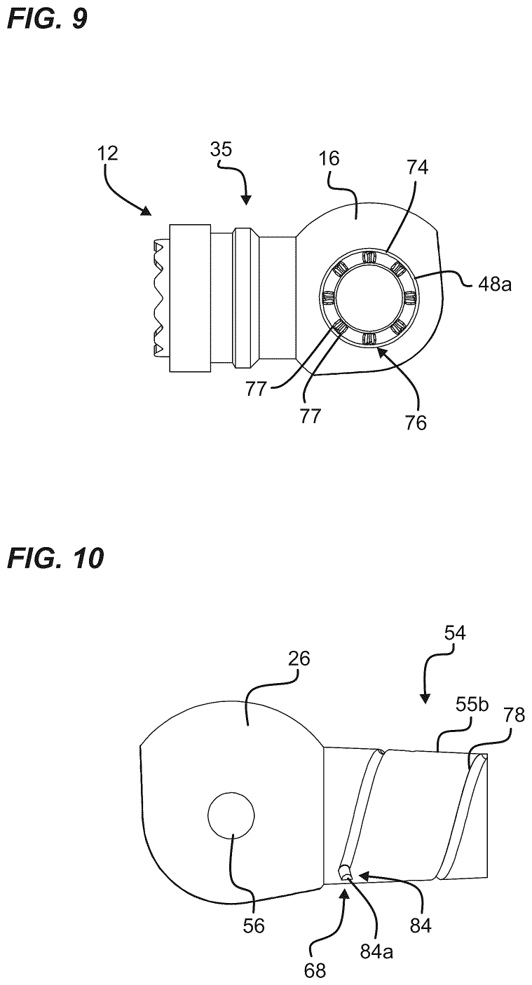

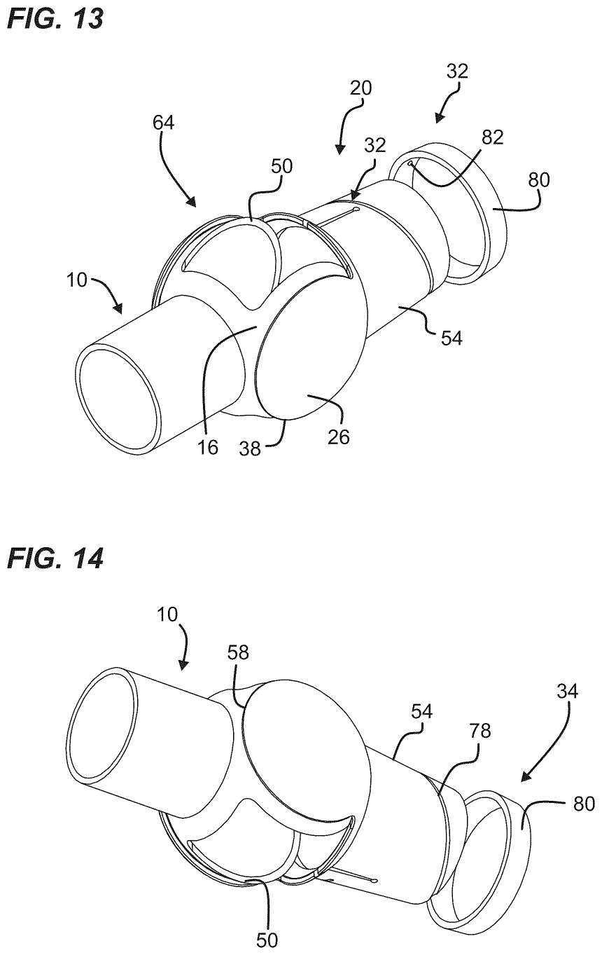

FIGS. 1-12 depict an example device 2 in accordance with the principles of the present disclosure. In one example, the device 2 is a backshell for providing a transition between a cable and a connector. The device 2 can be configured to provide strain relief for preventing cable structures (e.g., electrical wires, optical fibers) of the cable from being pulled from the connector. The device 2 can be configured for guiding the cable structures through the transition. As depicted, the device 2 includes an assembly 5 having a first end 12 defining a first port 14 and a second end 22 defining a second port 24 (best shown in FIG. 7). The assembly 5 defines a passage 66 (best shown in FIG. 12) that extends through assembly 5 from the first end 12 to the second end 22, where the first end 12 defines a first end axis A1 (shown in FIG. 7), and the second end 22 defines a second end axis A2 (shown in FIG. 7). The passage 66 is configured for receiving the cable structures. The assembly 5 can be pivotally adjustable about a pivot axis A3 (shown in FIG. 7) to adjust an angle between the first end axis A1 and the second end axis A2. FIG. 9 shows that the assembly includes a first body 10 which defines the first end 12 of the assembly 5 and the first body 10 includes a ball 16 through which the passage 66 extends. In some examples, the first body may be referred to as a backshell body. The first body 10 may further include a first passage-defining portion 35 (shown in FIG. 12) that extends along the first end axis A1 from the ball 16 to the first end 12 of the assembly 5. As shown in FIGS. 4-6, and 10, the assembly 5 also includes a second body 20 defining the second end 22 of the assembly 5. In some examples, the second body 20 may be referred to as a cable management structure. The second body 20 includes a socket structure 26 that mounts over the ball 16 of the first body 10 and the second body 20 also includes a second passage-defining portion 54 that extends along the second end axis a2 from the socket structure 26 to the second end 22 of the assembly. As shown in FIG. 5-7, the socket structure 26 and the ball 16 define a pivot interface 64 when the socket structure 26 is mounted over the ball 16. The pivot interface 64 is adapted to allow relative pivotal movement between the first and second bodies 10,20 about the pivot axis a3 for allowing adjustment of the angle defined between the first and second end axes a1, a2 of the assembly. The second body 20 further defines a socket expansion slot 28 (best shown in FIGS. 1 and 6) that extends through a portion of the second passage-defining portion 54 of the second body 20, where the socket expansion slot 28 (shown best in FIG. 6) allows the socket structure 26 to be expanded. FIGS. 2, 9, 11, and 12 show an angular retention arrangement 30 (best shown in FIG. 2) is included within the assembly 5 and the angular retention arrangement 30 is defined between the ball 16 and the socket structure 26. The angular retention arrangement 30 allows the assembly to be set at a plurality of angular positions. The angle defined between the first and second end axes a1, a2 of the assembly is different at each angular position of the assembly 5. As shown in FIG. 1, the assembly 5 further includes a locking mechanism 32 for allowing the assembly 5 to be set in a locked state in which constriction of the expansion slot 28 limits (e.g., restricts, prevents) expansion of the socket structure 26. When the socket structure 26 is in the locked state the assembly 5 can be locked in a selected one of the angular positions. When the assembly 5 is not in the locked state, the socket structure 26 is allowed to expand to permit the angular position of the assembly 5 to be adjusted about the pivot axis a3. In some examples, the unlocked state may be described as a first state and the locked state as a second state. Further, in some examples, the first body is a backshell body and the second body is cable management structure, where the angular retention arrangement is resiliently biased toward the second state by a construction of the backshell body and/or a construction of the cable management structure. Further, the angular retention arrangement is resiliently biased toward the first state by a construction of the backshell body and/or a construction of the cable management structure, and wherein a retainer is used retain the angular retention arrangement in the second state.

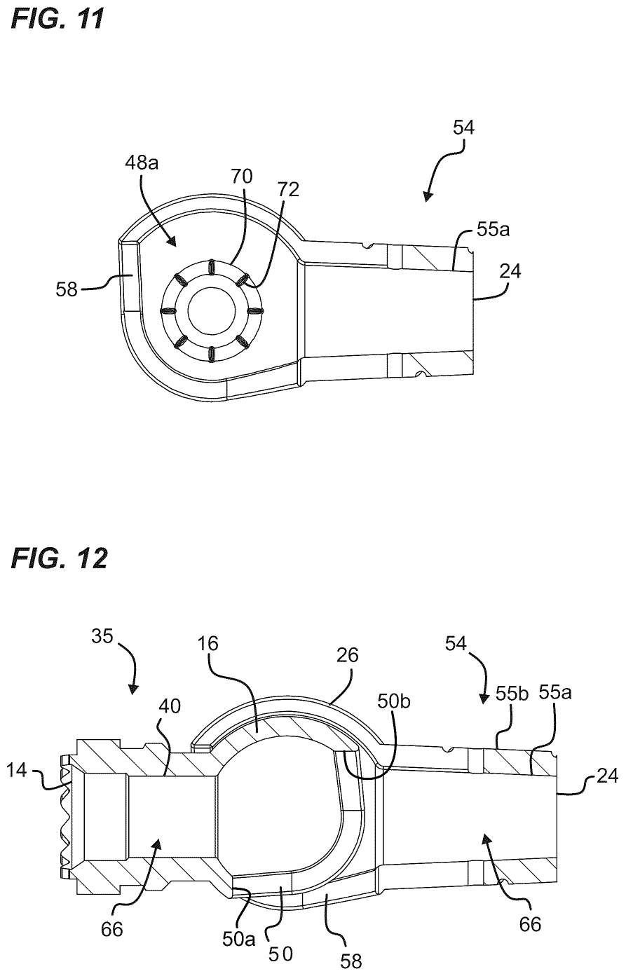

In one example, rather than providing universal pivotal movement, the assembly 5 is configured to allow for pivotal movement between the first and second bodies 10, 20 only about the pivot axis a3. For example, a circular bearing structure can be provided at the pivot interface (e.g., between the ball 16 and the socket structure 26) for restricting pivotal movement between the first and second bodies 10, 20 to pivotal movement about the pivot axis a3. In one example, the bearing structure can include a raised ring 70 (shown in FIG. 11) defined by one of the ball 16 and the socket structure 26 that fits within a circular groove 74 (shown in FIG. 9) defined by the other of the ball 16 and the socket structure 26. The raised ring 70 and the circular groove 74 are preferably co-axially aligned with the pivot axis a3. In the depicted example, first and second circular bearing structures having the same construction described above are provided about the pivot axis a3 on diametrically opposite sides of the ball 16.

In one example, the first end 12 of the assembly 5 can be adapted to mechanically couple (e.g., via a fastening arrangement) to the back end of a connector (e.g., an electrical connector) and the second end 22 of the assembly can be adapted to mechanically couple to a cable (e.g., a jacketed portion of a cable, a cable bundle, etc.). Cable structures (e.g., electrical wires, optical fibers) of the cable or cable bundle are routed through the passage 66 from the second end 22 to the first end 12 and are coupled to the connector adjacent the first end 12. In certain examples, the assembly 5 provides strain relief that allows strain to be transferred from the cable to the back end of the connector to prevent strain from being applied to the cable structures routed through the passage 66 and terminated at the connector. In certain examples, the device 2 does not include a removable pivot pin that joins between the pivoting arrangement of the first and second body.

FIG. 2 shows that the socket expansion slot 28 of the second body 20 may include an end 29 that opens into an angular adjustment slot 58 which is defined by the socket structure 26. As depicted, the second body 20 defines two socket expansion slots 28 positioned on diametrically opposite sides of the socket structure 26. The expansion slots 28 have ends 29 that open into the angular adjustment slot 58 at opposite ends 58a, 58b (shown in FIG. 2) of the angular adjustment slot 58. The ball 16 is positioned in a socket defined by the socket structure 26 to define the pivot interface 64. The first passage-defining portion 35 projects through the angular adjustment slot 58. The angular adjustment slot 58 has a length that extends circumferentially about the pivot axis A3 between the opposite ends 58a, 58b of the angular adjustment slot 58. The angular adjustment slot 58 is configured to define a range of pivotal movement allowed between the first and second bodies 10, 20. For example, the first body 10 may only rotate the length between the opposite ends 58a, 58b of the angular adjustment slot 58. The ball 16 defines a ball slot 50 (see FIGS. 11 and 12) configured to overlap with the angular adjustment slot 58. The ball slot 50 is configured to provide clearance within the assembly 5 for allowing the cable structures to transition from the second body 20 to the first body 10 as the cable structures extend through the passage 66. The ball slot 50 has a length that extends circumferentially about the pivot axis a3 between first and second ends 50a, 50b of the ball slot 50. In the preferred embodiment, the ball slot 50 curves at an approximate angle of 90 degrees (shown in FIGS. 9 and 12) between the ends 50a, 50b. In some instances, the curvature angle of the ball slot 50 and the angular adjustment slot 58 can be greater than 90 degrees (shown in FIG. 13.) to allow larger degree of rotation within the pivot interface 64.

The pivot interface 64 is rotatable to change the angle between the first and second ends 12, 22 to a desired angle and the passage 66 accordingly may guide objects through the passage 66 at the desired angle. As can be seen in FIG. 1, the second body 20 may be placed in the locked state by the locking mechanism 32. The locking mechanism 32 includes a constriction portion 68 and a constricting device 34. The constricting device 34 (shown in FIGS. 1 and 14) may engage with the second passage-defining portion 54 (shown in FIGS. 6 and 10) of the second body 20 at the constriction portion 68. The constriction portion 68 and the constricting device 34 can have a tapered configuration that causes constriction of the socket structure 26 upon tightening of the constricting device 34.

FIGS. 1 and 5-7 illustrate the assembly in different angular positions. The different angular positions may include an in-line position (shown in FIG. 1), a right-angle position (shown in FIG. 5), and one of a plurality of intermediate position (shown in FIG. 6) between the in-line position and right-angle position. In the in-line position, the pivot interface 64 may be configured such that the first axis end a1 and the second end axis a2 are coaxial. In the right-angle position, the pivot interface 64 may be configured such that the angle between the first end axis a1 and the second end axis a2 may be positioned perpendicular to each other. In one example intermediate position, the pivot interface 64 may be configured such that the angle between the first end axis a1 and the second end axis a2 may be positioned at a 135-degrees. The assembly 5 preferably has a plurality of intermediate positions each having a different angle.

FIGS. 7-9, and 12 illustrate the first body 10 of FIG. 1. The first passage-defining portion 35 of the first body 10 may further define an interior circumferential surface 40 (shown in FIG. 12). The first end 12 can be configured for coupling to the rear end of a connector (e.g., with the aid of a fastener such as a nut).

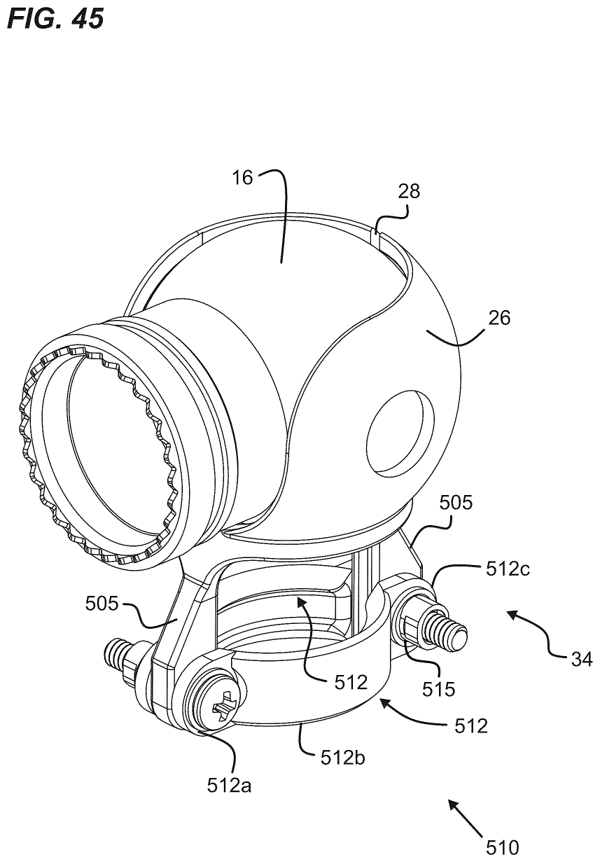

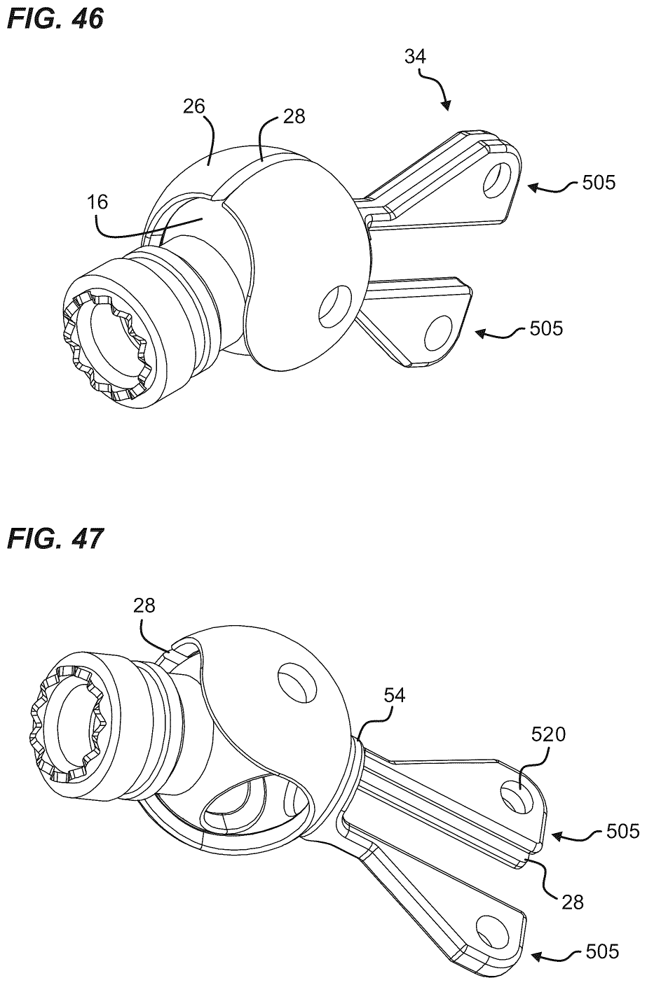

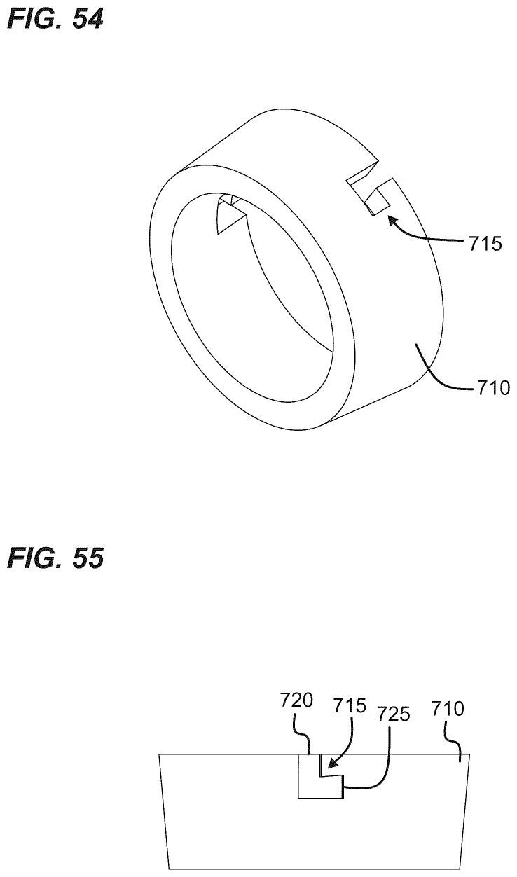

In some instances, the angular retention arrangement 30 may include a plurality of retention projections defined by one of the ball 16 or the socket structure 26 and plurality of projection receptacles 76 (e.g., troughs, slots, notches) defined by the other of the ball 16 and the socket structure 26. The arrangement of retention projections and projection receptacles 76 can be configured to surround the pivot axis a3. In the depicted example, the retention arrangement includes first and second retention regions 48a, 48b (shown in FIGS. 8 and 9) positioned on diametrically opposite sides of the ball 16. Each of the retention regions 48a, 48b includes a plurality of projection members 72 provided within the socket structure 26 that are circumferentially spaced (e.g., uniformly spaced) about the pivot axis A3. The projection members 72 can be incorporated with the raised rings 70 (see one of the raised rings 70 at FIG. 11). The raised rings 70 encircle the pivot axis a3 and are configured to project inwardly from a main interior surface of the socket structure 26. The raised rings 70 are co-axial with the pivot axis A3 and concentric with respect to openings 56 defined through a wall of the socket structure 26. As depicted at FIG. 11, the projection members 72 can be positioned on the raised rings 70 and can have lengths that extend radially relative to the pivot axis A3. Each of the first and second retention regions 48a, 48b also includes a plurality of projection receptacles 76 provided on an exterior of the ball 16 (see FIGS. 8 and 9). The projection receptacles 76 are configured to receive the projection members 72 to set the assembly 5 at a desired angular position. The projection receptacles 76 of each retention region 48a, 48b are circumferentially spaced (e.g., uniformly spaced) about the pivot axis a3. The projection receptacles 76 can be incorporated within the grooves 74. The projection receptacles 76 can be defined between pairs of raised ridges 77 positioned within the grooves 74. When the assembly 5 is not in the locked state, the socket structure 26 can resiliently expand and contract to permit the projection members 72 to ramp in and out of the projection receptacles 76 as the assembly 5 is manually rotated to the different angular positions. Once the assembly 5 has been moved to a desired angular position and the projection members 72 are received within the projection receptacles 76, the assembly 5 can be locked via the constriction device 34 (shown in FIGS. 1, 13, 37, 41, 44, 50, and 54) such that expansion of the socket structure 26 is restricted and the projection members 72 are thereby prevented from ramping out of the projection receptacles 76. In this way, the assembly 5 can be locked in the desired angular position. In the depicted, the retention arrangement established eight different angular positions. In other examples, the number of angular positions can be varied to more or less than eight.

The number of projection receptacles 76 may match the number of projection members 72. The plurality of projection receptacles 76 are spaced equidistantly around the circular groove 74 such that the each of projection members 72 may fit within one of the projection receptacles 76 when in a locked state. As the ball 16 is rotated, the projection members 72 will be placed in a different receptacle 76 such that the first body 10 is rotated in defined pre-defined increments between angular positions (e.g., 45-degree increments). When engaged within the receptacles 76, the projection members 72 pre-set the socket structure 26 at a desired angular position. Once the assembly 5 is pre-set to the desired angular position, the constriction device 34 can be tightened to lock the assembly 5 in the desired angular position. Providing the wire passage 66 with the capability of changing angles allows positioning of wires with reduced wear or damage such as crimping. Further, the need for multiple assemblies with different designs achieving only a single angle between the first and second bodies may be eliminated. Also, in certain examples, the angle can be adjusted by merely loosening the assembly rather than requiring disassembly of the assembly.

FIGS. 1, 2, 7 and 10-12 illustrates the second body 20 of FIG. 1. In some instances, the second passage-defining portion 54 may be tapered at both the interior 55a and exterior circumferential surfaces 55b (shown in FIGS. 11 and 12). In other instances, the second passage-defining portion 54 may be a cylinder with straight sides. The socket expansion slot 28 extends at least partially through a portion of the second passage-defining portion 54 and longitudinally into the socket structure 26 on at least one side of the second body 20. The socket expansion slot 28 may be configured in a V shaped cut through of the second body 20. In other instances, the socket expansion slot 28 may be other shapes, such as a straight cut. At least one socket expansion slot 28 may be constricted at the constriction portion 68 (shown in FIGS. 1 and 12) of the second passage-defining portion 54 to limit expansion of the socket structure 26. In some instances, at least two slots 28 may be provided on the second body 20 to be constricted. In the depicted example, the socket expansion slots 28 include first and second socket expansion slots 28 positioned on diametrically opposite sides of the second passage-defining portion 54 and the first and second socket expansion slots 28 are aligned along a reference plane oriented perpendicular to the pivot axis.

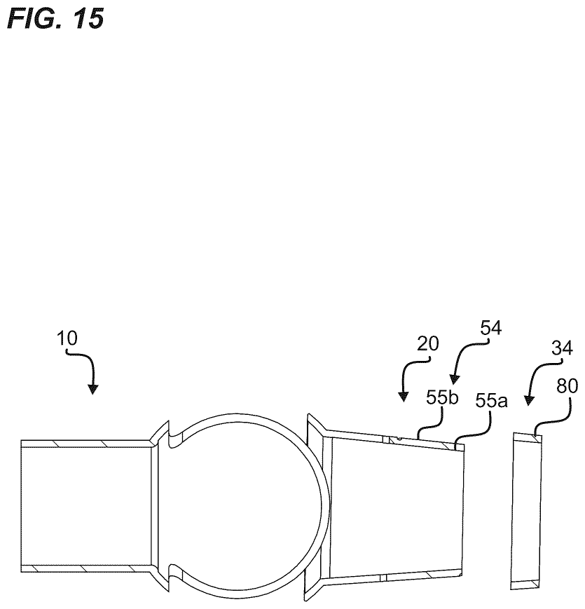

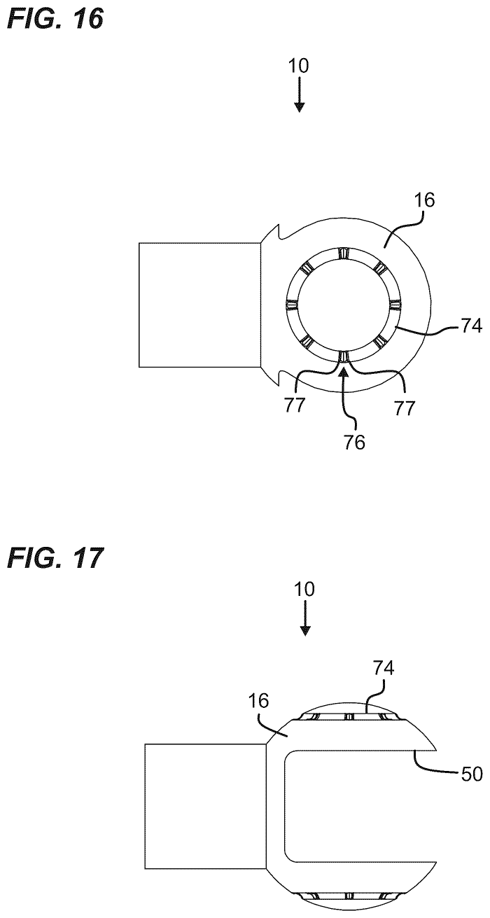

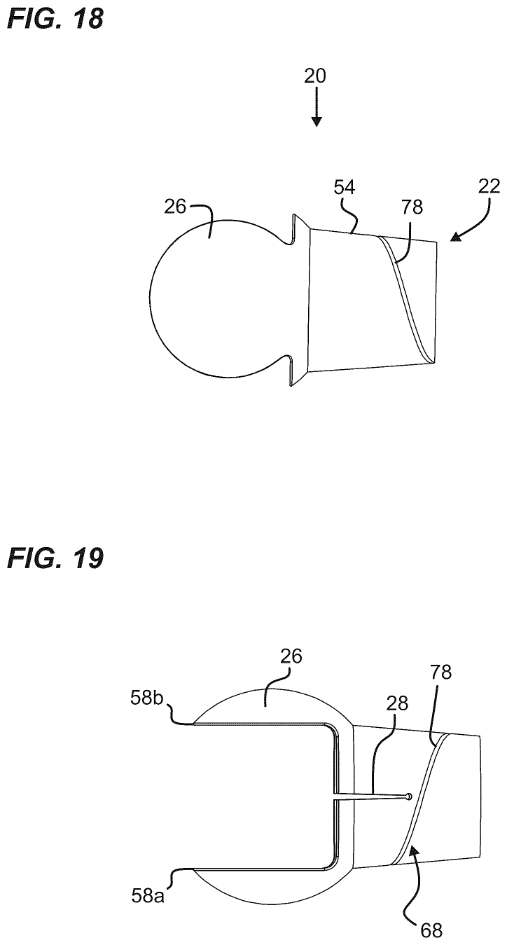

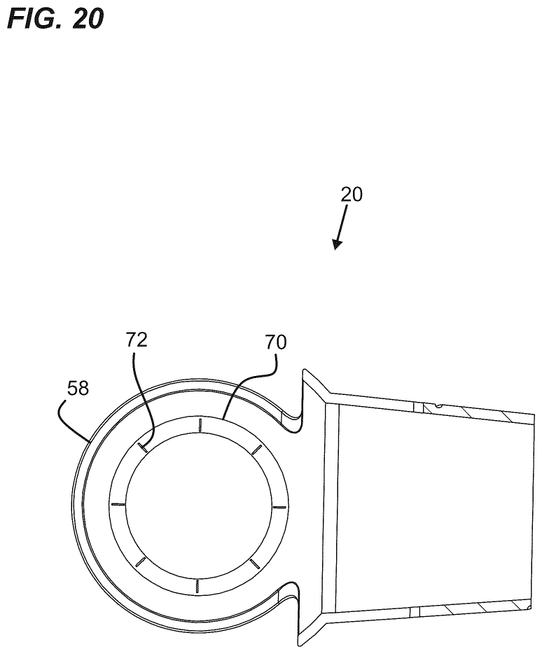

FIGS. 13-20 depict an alternate embodiment of FIG. 1, where the pivot interface 64 has a greater range of motion, and the first end axis a1 may be rotated within at least a 315-degree range about the axis a3 relative to the second end axis a2. The pivot interface 64 can now be rotated to a second right angle position which is 90-degrees relative to the first position in an opposite direction of rotation from the right-angle position. For instance, the first end 12 of the first body may be rotated 90 degrees from the in-line position to the fourth side of socket structure 26. The increased range of motion allows only a single axis of rotation. Further, the plurality of intermediate positions may be positioned between the in-line position and the second right angle position. As previously explained, retention positions can define predefined angular positions separated by predetermined angular increments. In one example, the plurality of retention positions allow the first end axis a1 to be positioned in at least 90, 135, 180, 225, 270, and 315 degree positions relative to the second end 22.

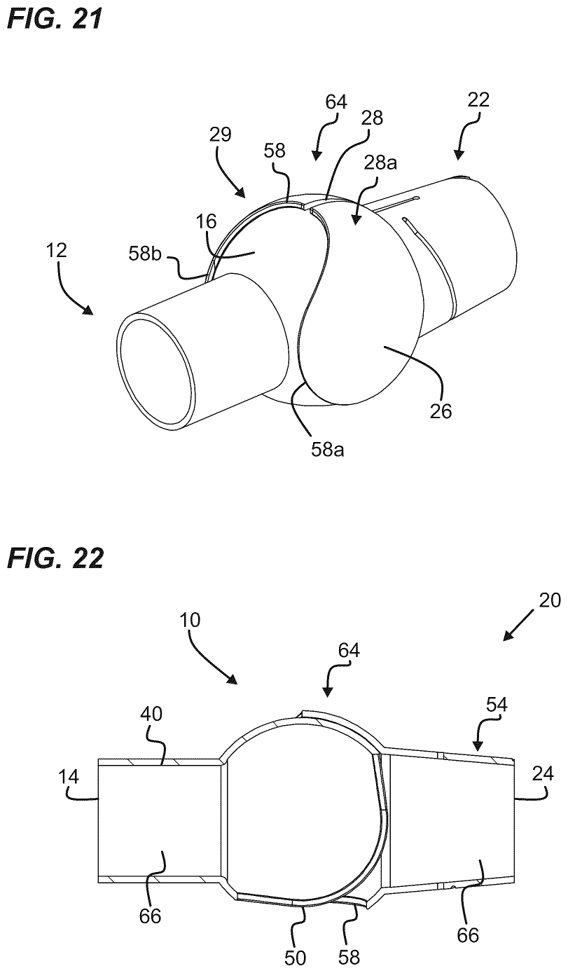

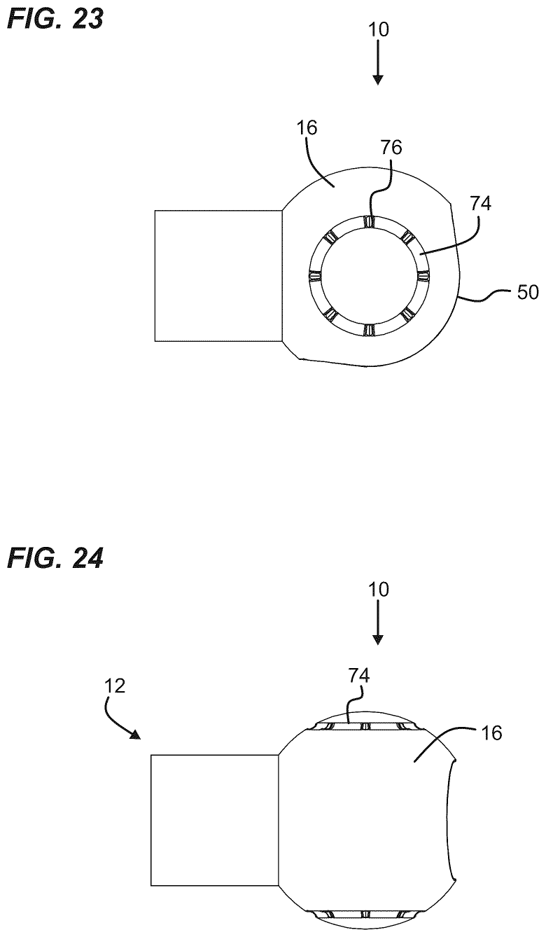

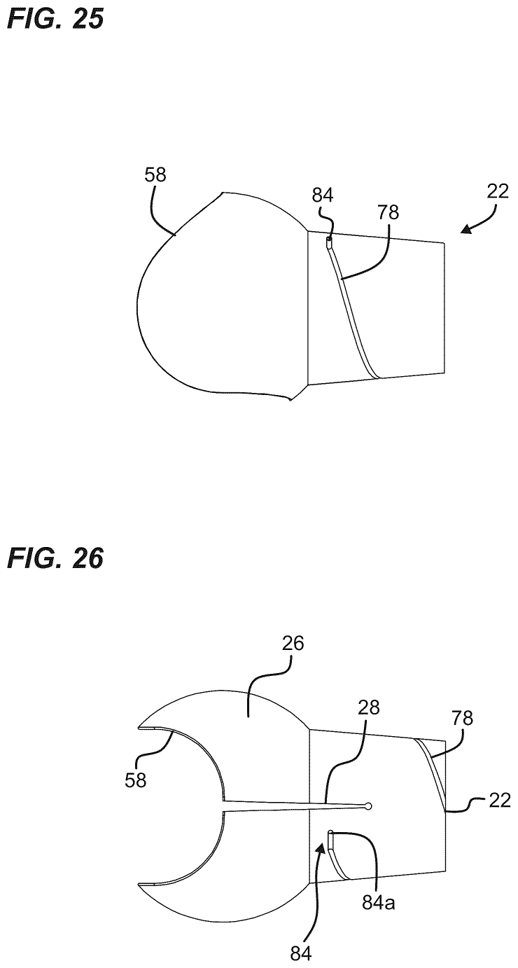

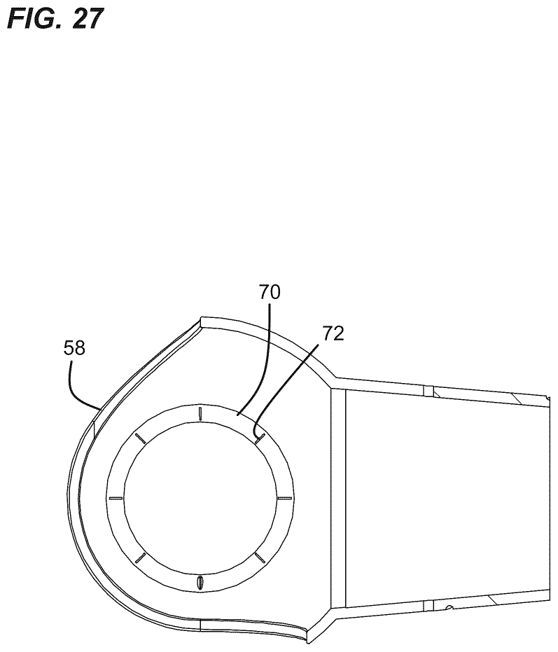

FIGS. 21-27 show another alternate embodiment of FIG. 1, where the first end axis a1 may be rotated within at least a 225-degree range about the axis a3 relative to the second end axis a2. The assembly can now be maximally rotated to an end position which is rotated 45-degrees relative to the in-line position in an opposite direction of rotation from the right-angle position. In one example, the plurality of retention positions allows the first end axis A1 to be positioned in at least 90, 135, 180, and 225-degree positions relative to the second end axis a2.

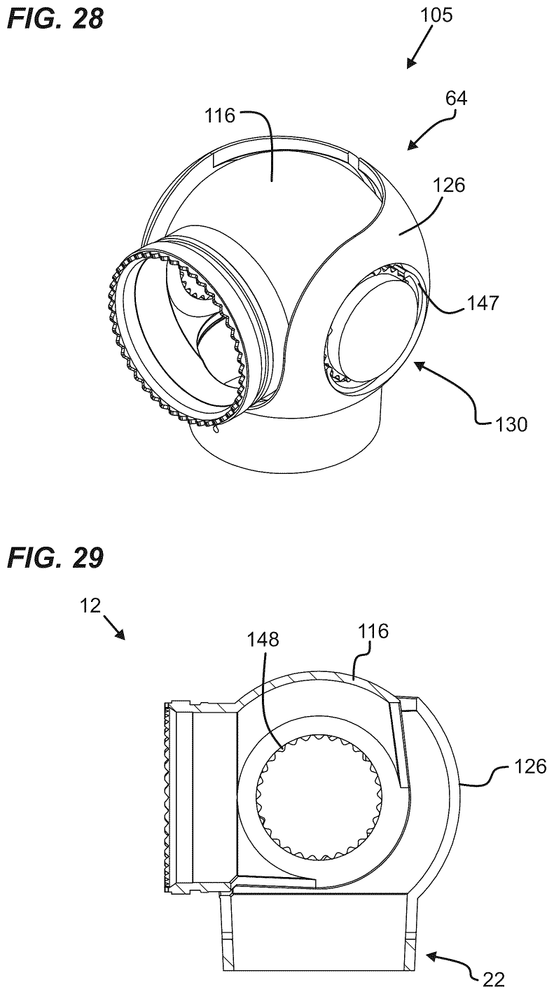

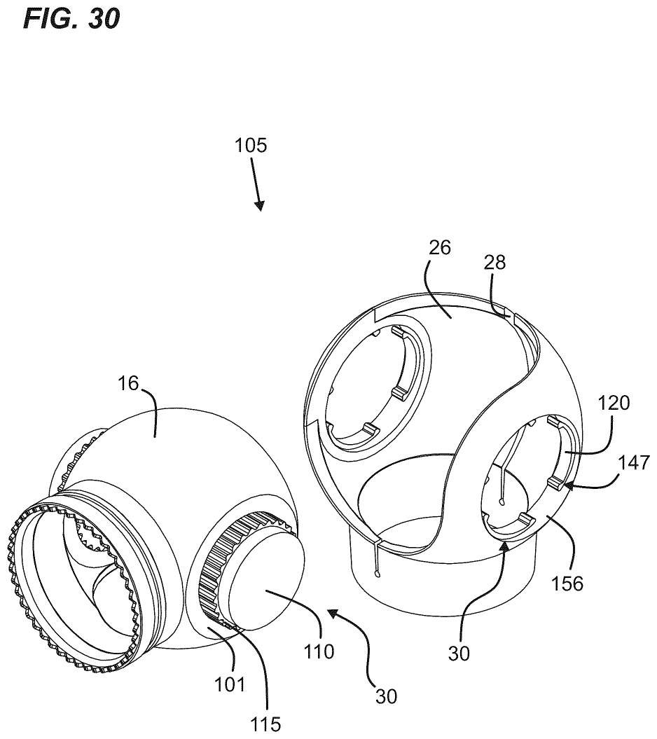

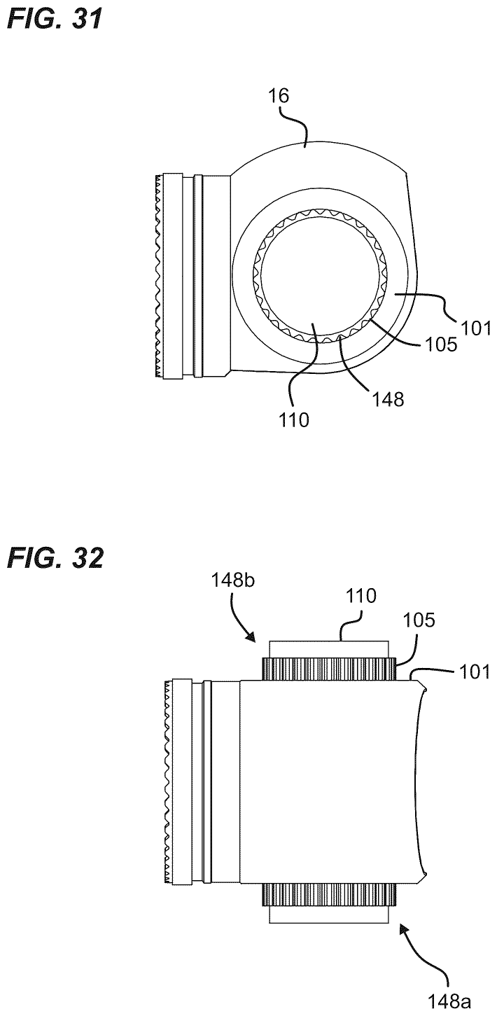

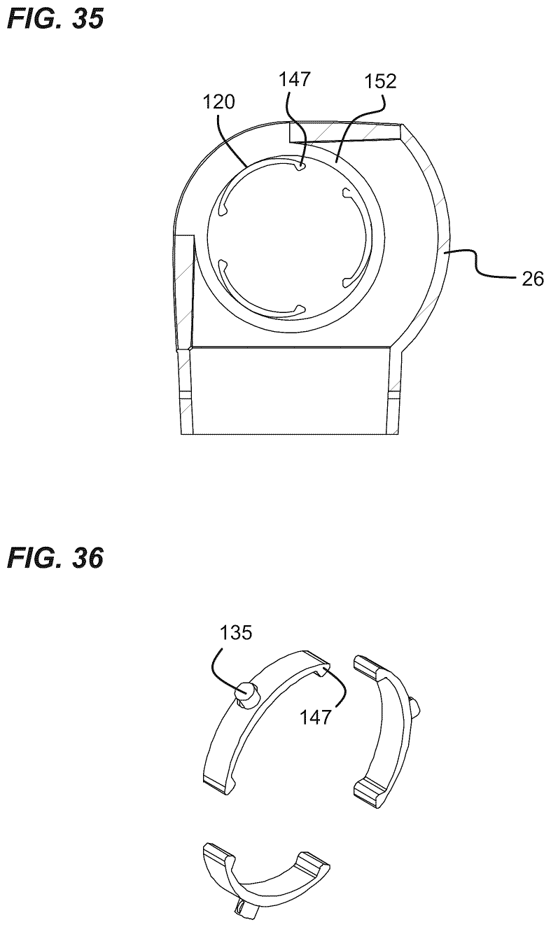

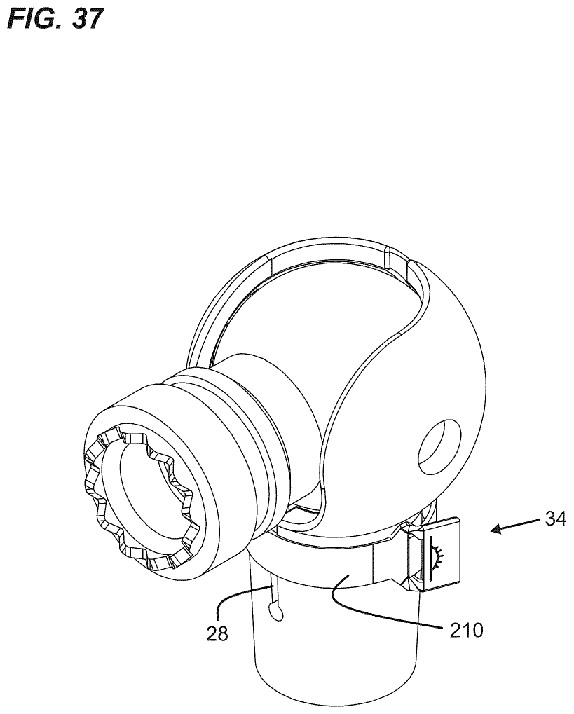

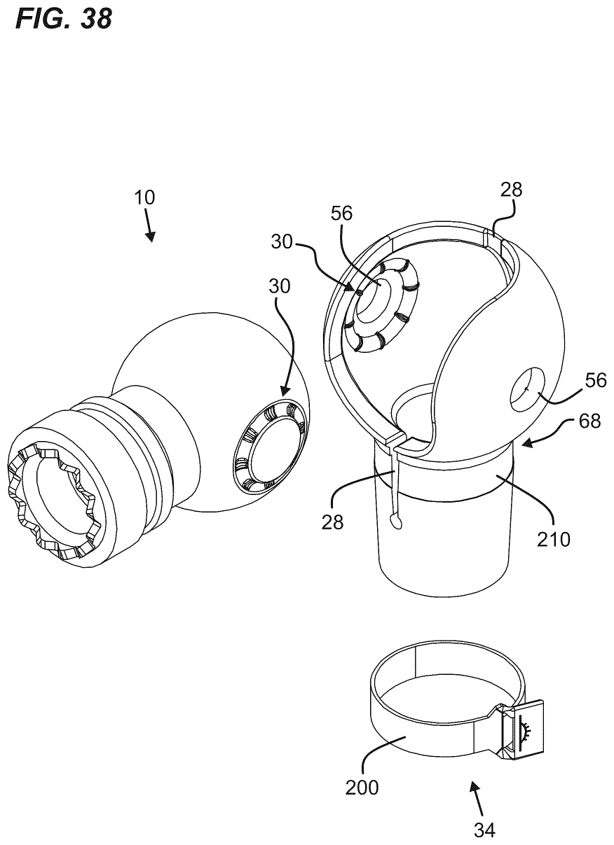

FIGS. 28-36 illustrate and alternative assembly 105 having an alternative angular retention arrangement 130. Here, the angular retention arrangement 130 may include angular retention regions 148a, b positioned on opposite sides of a ball 116. Each of the angular retention regions can include projections 147 and receptacles 148. In one example, the ball 116 can include the receptacles 148 and the socket structure 126 can include the projections 147, but as with the other examples disclosed herein this can be reversed. FIG. 24-26 show the ball 116 including a flat surface 101 on opposite sides of the ball 116. The flat surface 101 further includes a toothed region 115 and a cylindrical surface 110. The toothed region 115 and the cylindrical surface 110 extend outward from the exterior of the ball and the toothed region 115 is positioned between the flat surface 101 and the cylindrical surface 110. The flat surface 101, the toothed region 115, and the cylindrical surface 110 are coaxially aligned. The flat surface 101 having a diameter larger than the toothed region 115 and the cylindrical region 110 having a diameter smaller than the toothed region. The receptacles 148 are defined between the teeth of the toothed region 115.

A socket structure 126 of the assembly 105 includes openings 156 which allow the cylindrical surface 110 and toothed region 115 of the ball 116 to be inserted through each of the respective openings 156. Flat interior ring surfaces 152 of the of the socket structure 26 oppose the flat surfaces 101 of the ball 16 when the ball 16 is installed within the socket structure 126.

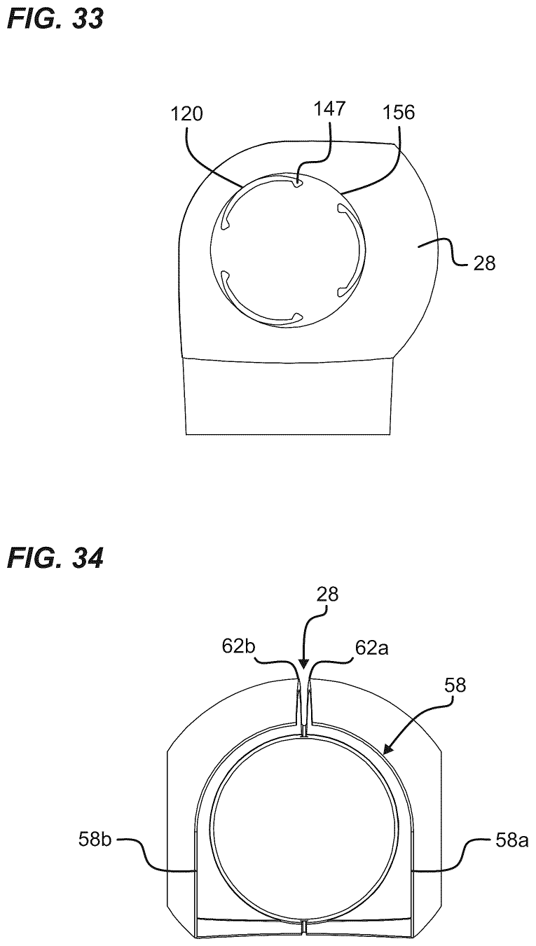

In some instances, projection-defining inserts 120 mount within the openings 156. The projection-defining inserts 120 define the projections 147 adapted to fit within the receptacles 148 defined between the teeth of the toothed region 115. In some instances, the openings 156 may further include a plurality of pin holes 175 (shown in FIG. 33) positioned at equidistant locations around the entire circumference of the two openings 56. The pin holes 175 receive pins 135 of the inserts 120 for securing the inserts 120 within the openings 156. The projections 147 of the insert 120 engage with the toothed region 115 to lock the assembly 105 in the locked state and prevent rotation of the ball 116 within the socket structure 126. The inserts 120 are positioned within the two openings 56 so that when the second socket structure 126 is constricted, the inserts encompass the first and second retention regions 148a, b, causing the projections 147 to mate with the toothed region 115. However, when the socket structure 126 is in the expanded state, the inserts 120 are positioned with the opening 156 and around the cylindrical surface 110. As an example, three inserts 120 may be equidistantly spaced around the circumference; however, more or less inserts 120 may be utilized.

The constriction portion 68 and the constriction device 34 of FIGS. 1-32 may be used with any embodiment of the retention arrangement 30. For instance, as shown in FIGS. 1 and 13, the constriction portion 68 may be a segment of the second passage-defining portion 54 which allows the constriction device 34 to engage with the second body 20 to constrict the socket expansion slot 28. For instance, in the embodiment of FIG. 4, the constriction portion 68 includes a helical cut 78 extending around a longitudinal direction of the exterior circumferential surface of the second passage-defining portion 54. The constriction device 34 may be a locking band 80 with an interior protrusion 82 (shown best in FIG. 13) which may be inserted onto the second end 22 within the helical cut 78. The constriction portion 68 further includes an end 84 of the helical cut 78 adjacent to the socket structure 26 which defines an indentation 84a (shown in FIG. 10) for locking the interior protrusion 82 of the locking band 80 in place on the second passage-defining portion 54 when the socket structure 26 has reached the locking position around the ball 16. When inserted onto the second end 22, the interior protrusion 82 may be positioned within the helical cut 78 such that the locking band 80 may be twisted to follow the helical cut 78 longitudinally towards the socket structure 26 to the indentation 84a. As the locking band 80 engages towards the socket structure 26, the locking band 80 constricts the socket expansion slot 28 of the socket structure 26 towards a locked state (shown in FIG. 1). At the locked state, the socket structure 26 is constricted to engage the ball 16 at the retention arrangement 30 and the protrusion of the locking band 80 is positioned within the indentation 84a. In some instances, a diameter of the helical cut 78 may be made larger to match a different interior protrusion 82 of the locking band 80. In other embodiments, the helical cut 78 may be a plurality of helical cuts 78 and the locking band 80 may include a plurality of interior protrusions 82. The plurality of interior protrusions 82 each rotatable through a respective helical cut 78 to constrict the second passage-defining portion 54. In certain examples, alternative threaded interfaces can be provided between the constriction device 34 and the second end of the assembly 5.

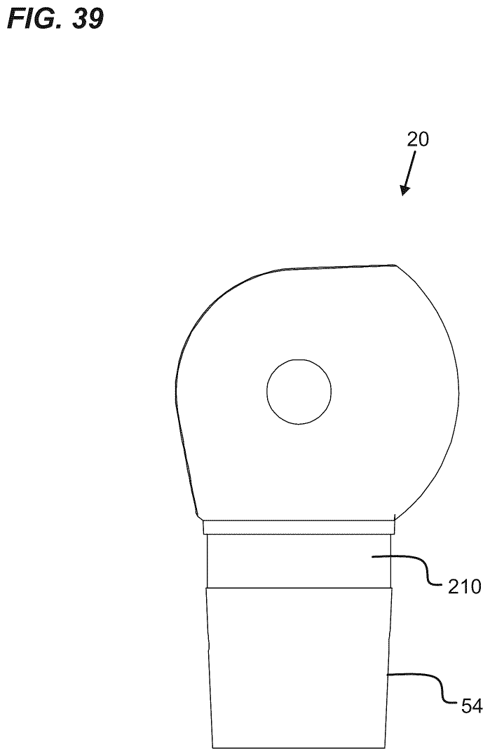

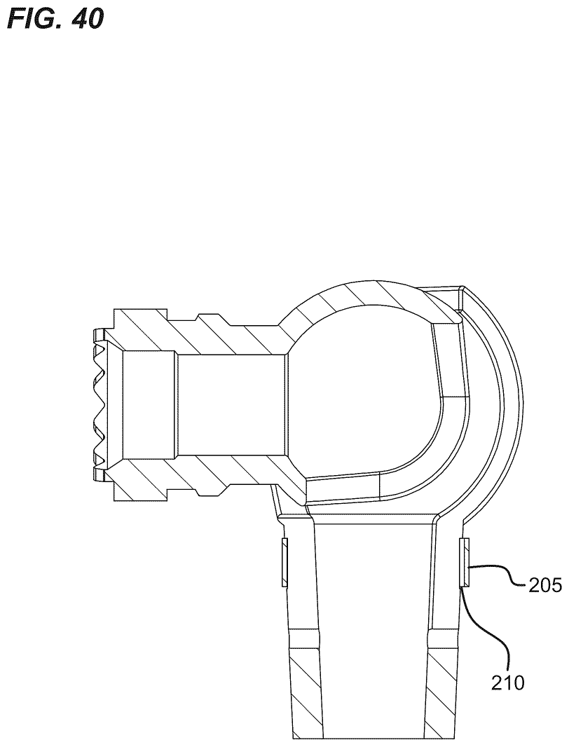

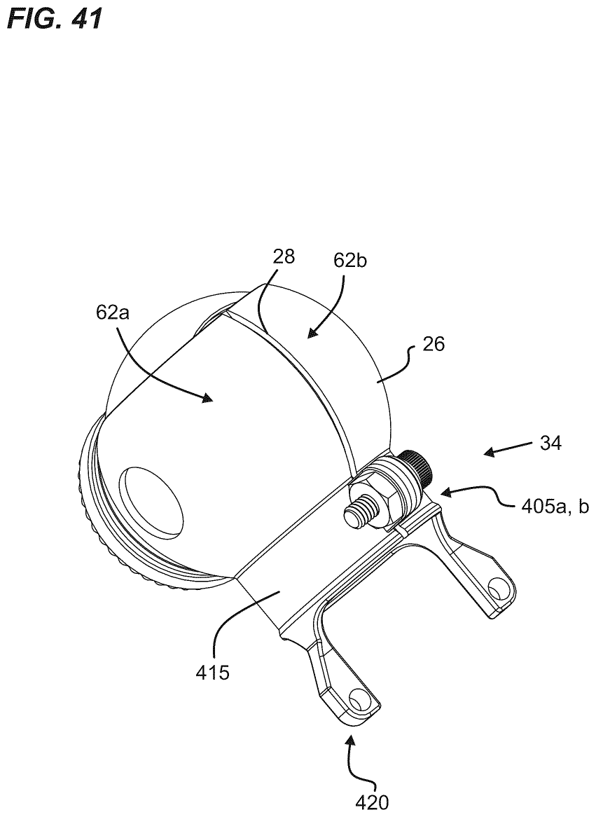

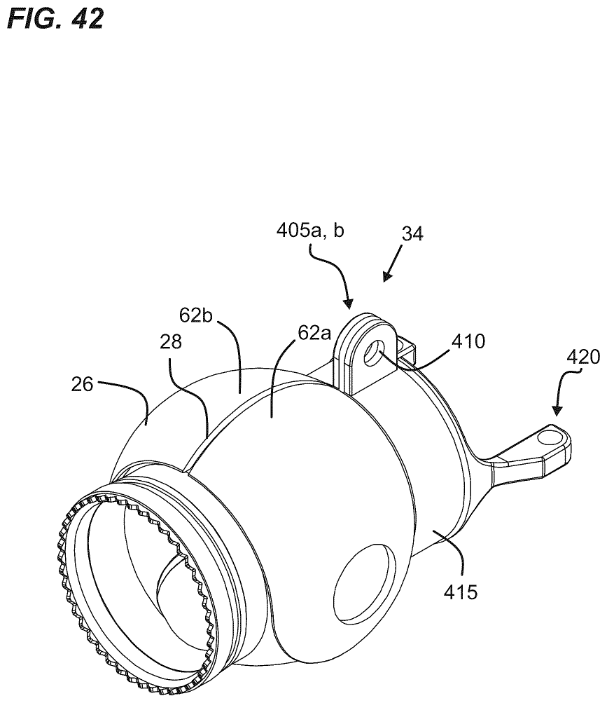

In the embodiment of FIG. 37-40, the constriction portion 68 may be an engagement surface 210 around the exterior circumference of the second passage-defining portion 54. In FIG. 37, the constricting device 34 is a locking strap 205, which may be inserted over the second end 22 to the engagement surface 210. The engagement surface 210 may have a smaller exterior circumferential surface than the rest of the second passage-defining portion 54. The locking strap 205 may be pulled to tighten around the exterior circumference of the engagement surface 210 and constrict the socket expansion slot 28. As tightened, the strap 205 may lock in tightened positions. The locking strap 205 is inserted into the smaller exterior circumferential area and restricted from longitudinal movement along the second end axis A2 when tightened. As the socket expansion slot 28 is constricted, the socket structure 26 of the second body 20 is moved to engage the ball 16 of the first body 10 at the retention arrangement 30.

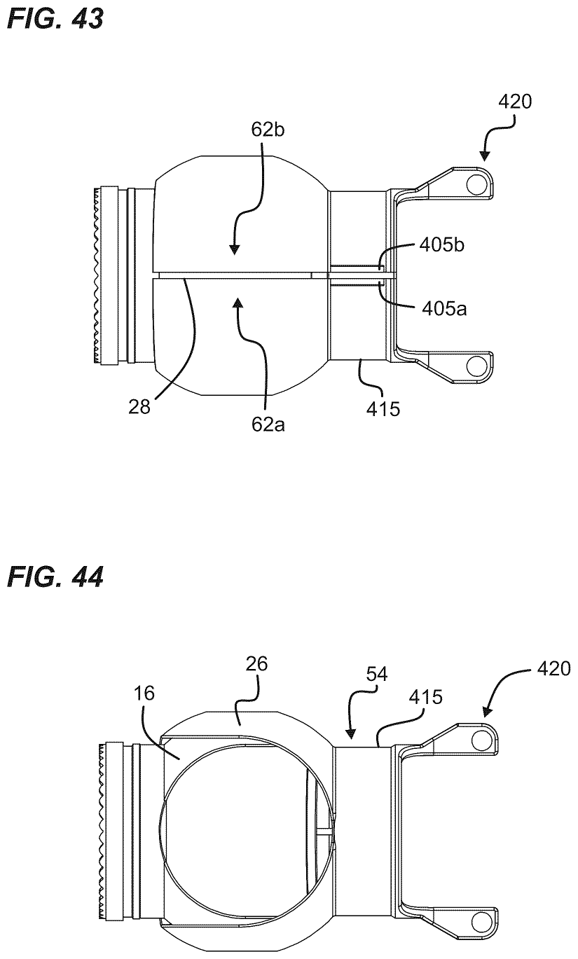

In the embodiment of FIGS. 41-44, the constriction portion 68 may include two flange portions 405a, b extending radially outward from the exterior surface 415 of second passage-defining portion 54. In FIG. 41, a first flange 405a may be positioned on the first side 62a of the socket expansion slot 28, and the second flange 405b may be positioned on the second side 62b of the socket expansion slot 28. The first and second flange 405a, b both include an opening 410. The openings 410 of the first and second flange 405a, b coaxially align at a position radially outward from the exterior surface 415 and perpendicular to the second end axis A2. The opening 410 allows a fastener to be inserted through both the first and second flange portion. When the fastener is tightened within the first and second flange 405a, b, the first and second flanges 405a, b pull together which constricts the socket expansion slot 28. When the slot is constricted the second body 20 moves to the locked state and the socket structure 26 of the second body 20 is moved to engage the ball 16 of the first body 10 at the retention arrangement 30. In some instances, the socket expansion slot 28 may extend through the entire second body 20. Further, in some instances, the second end 22 may also contain a pair of projections 420 extending from the second end 22 to be coupled with a cable (e.g., a cable bundle or jacket). Each projection 420 may further comprise a hole for a fastener to be inserted through for attachment of a cable clamp for clamping the cable to the backshell assembly.

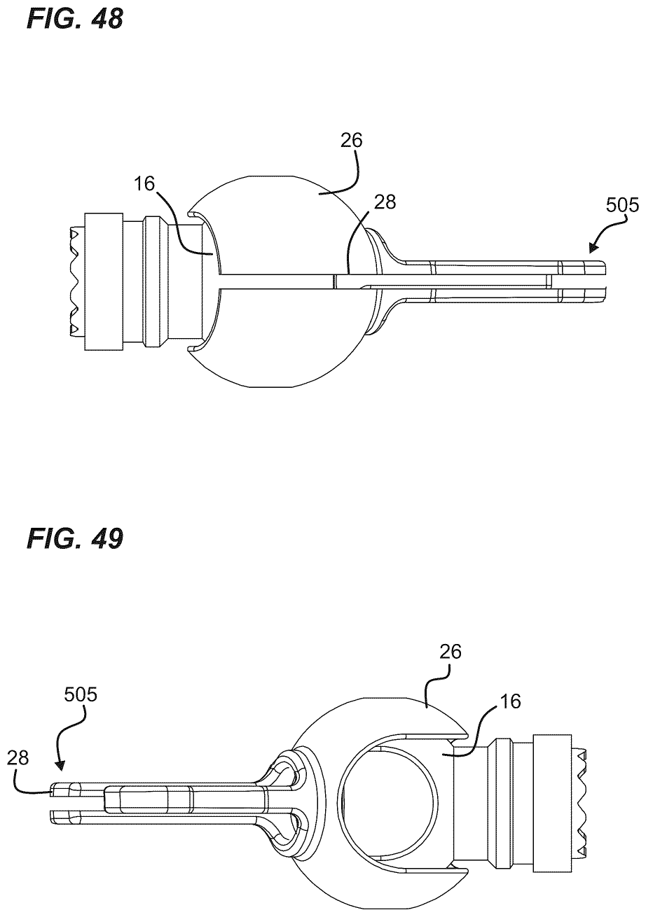

As shown in FIGS. 45-49, the constriction portion 68 may be a set of attachment members 505 (e.g., arms, links, extensions, etc.) with a socket expansion slot 28 extending through one of the attachment members 505. A cable clamp 510 (e.g., a saddle-style cable clamp as depicted) can be fastened to the attachment members 505 to concurrently clamp a cable to the backshell assembly and cause constriction of the slot 28 to limit expansion of the socket structure 26. Each of the attachment members 505 includes an opening 520. The cable clamp 510 include two clamp bodies 512. Each clamp body 512 includes a first flange area 512a, a semi-circle region 512b, and a second flange area 512c. The first and second flange areas 512a, c defining openings 515 for receiving fasteners. The fasteners may be inserted through the openings 515 of the flange areas and the openings 520 of attachment members 505 to constrict the attachment member 505 with the socket expansion slot 28 together. As the socket expansion slot 28 is constricted, the socket structure 26 of the second body 20 is moved to engage the ball 16 of the first body 10 at the retention arrangement 30. The attachment members are configured for attaching another structure (e.g., a clamp) to the pivotal assembly (e.g., the backshell assembly) and/or for attaching the pivotal assembly to another structure.

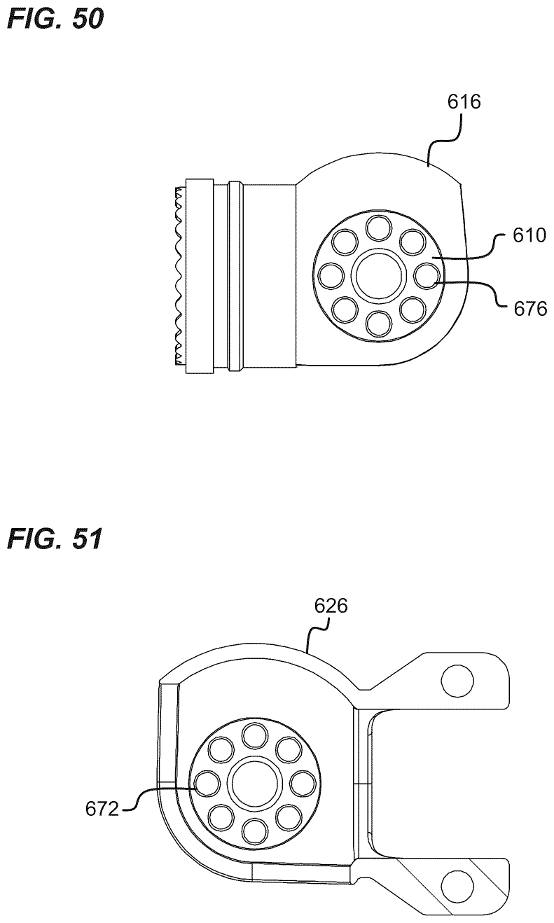

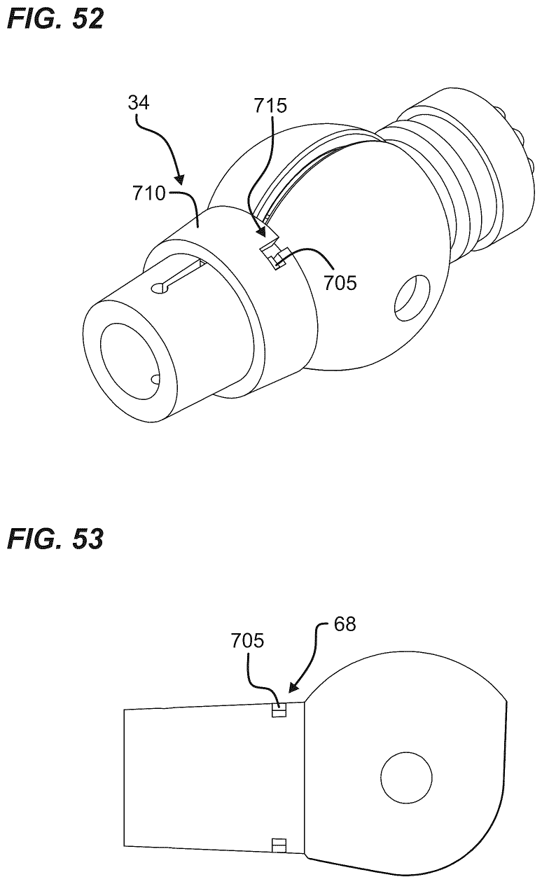

FIGS. 50. and 51 illustrate and alternate embodiment where projection receptacles 676 on a ball 616 may include circular receptacles (e.g., openings, depressions) defined within flat circular surfaces on opposites of the ball 16. The flat circular surfaces 610 may be coaxially aligned with the pivot axis a3 and perpendicular to the first end axis a1. The receptacles 676 can be spaced along a circle concentric with the pivot axis a3. As non-limiting examples, the receptacles may be spherical, conical or cylindrical. Projection projections 672 of a socket structure 626 may be similarly spaced along a circle concentric with the pivot axis a3. The projections 672 may be shaped protrusions to match the shape of the projection receptacles 676. As non-limiting examples the projection projections 672 may be spherical, conical or cylindrical shapes which match the respective shape of the projection receptacles 676.

In the embodiment of FIGS. 52-55, the constriction portion 68 may include pegs 705 extending radially outward from the exterior circumference of the second passage-defining portion 54. The pegs 705 may be preferably three projections; however, the number of projections may be more or less. As shown in FIG. 50, the pegs 705 are located near to the socket structure 26 of the second housing. The constricting device 34 may be a locking band 710 (shown in FIG. 52) with cutouts 715 formed to mate with the projections. In some instances, the pegs 705 may be square in shape and the cutout 715 may be an L-shaped cutout. In other instances, the pegs 705 may be another polygonal shape or means for clasping the cutout 715. A first end 720 of the cut out allows the peg 705 to be slid into a first end of the band 710. The band 710 may be twisted such that the peg 705 is slid to a second end 725 (best shown in FIG. 53) of the L-shaped cutout 715, and the second end of the L-shaped cutout 715 may have a smaller width than the square peg 705. When slid into the second end 725 of the cutout 715, the peg 705 is fit into the second and the larger diameter of peg 705 prevents the peg 705 from moving. When twisted and secured in the locked longitudinal position, the band 710 has a smaller inner circumferential area than the exterior circumferential area of the second passage-defining portion 54, which constricts the socket expansion slot 28. As the socket expansion slot 28 is constricted, the socket structure 26 of the second body 20 is moved to engage the ball 16 of the first body 10 at the retention arrangement 30. In certain examples, retention projections and corresponding retention receptacles in accordance with the principles of the present disclosure can function as detents.

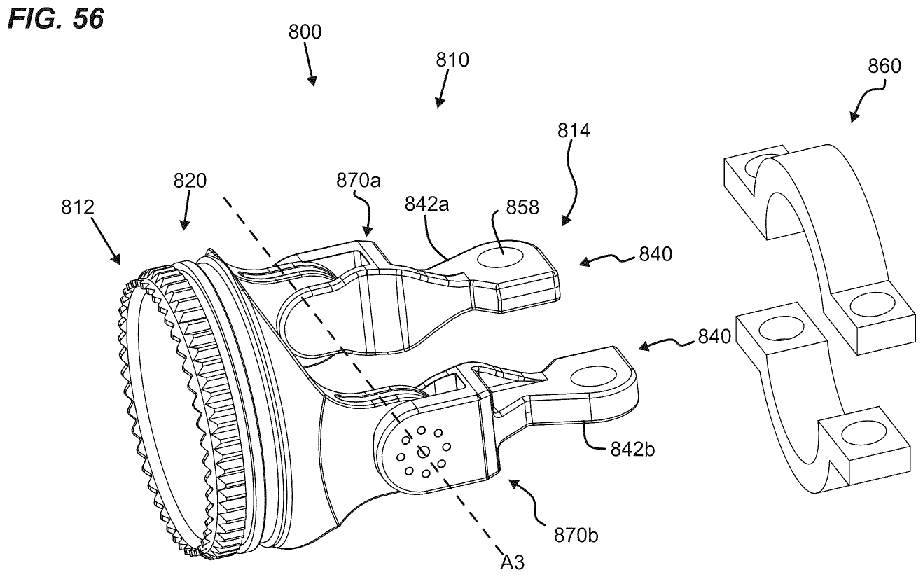

FIGS. 56-59 illustrates an alternative embodiment of a pivotal backshell device 800. Referring to FIG. 56, the backshell device 800 allows for a connection to a connector to provide strain relief and bend control of a cable connected to the connector. The example backshell device 800 may comprising a pivotal backshell assembly 810 having a first end 812 and a second end 814. The first end 812 is configured to connect to the connector and the second end 814 is configured to accommodate the cable. The first end being defined by a backshell body 820 and the second end 814 being defined by a cable management structure 840. The backshell body 820 and cable management structure 840 being pivotally moveable about a pivot axis A3 relative to each other between a plurality of different angular positions. In some instances, the backshell body 820 may be an integrally formed unitary body. In present example, the cable management structure 840 is formed by first and second separate attachment arms 842a, b connected by a cable clamp 860. In other examples, the cable management structure 840 may be formed by a single unitary body. The first and second attachment arms 842a, b each include an opening 858 for attachment of the cable clamp 860 via fasteners. The opening 858 may be positioned at the second end 814 of the pivotal backshell assembly 810. In certain examples, the pivotal backshell device does not include a removable pivot pin that joins between the pivoting arrangement of the first and second body.

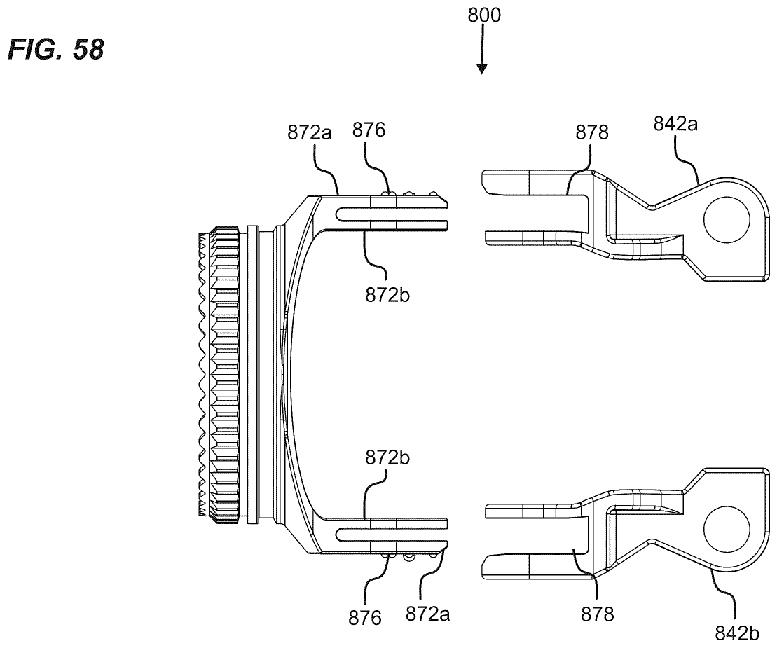

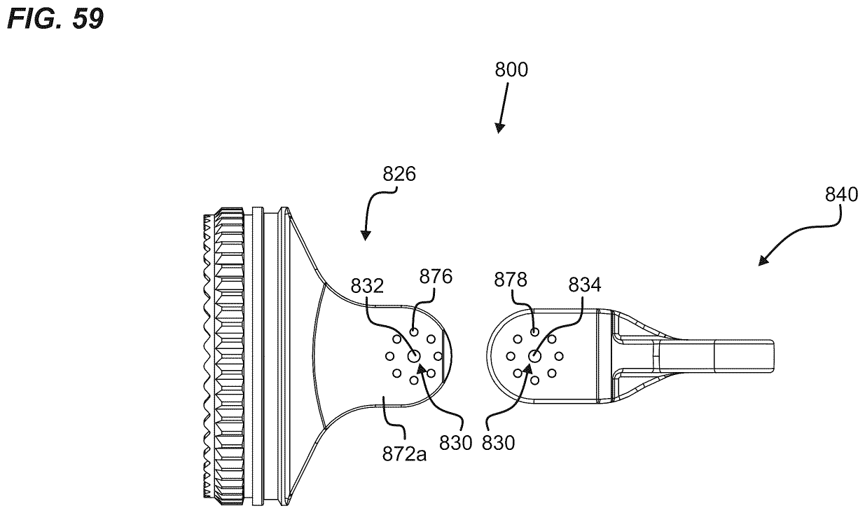

The pivotal backshell assembly 810 also includes an angular retention arrangement 870 for allowing the pivotal backshell assembly 810 to be set at a selected one of the different angular positions. Although discussed singularly, the pivotal backshell assembly 810 includes angular retention arrangements 870 on opposites sides of the assembly 810 about the pivot axis A3. The angular retention arrangement 870 includes at least one projection 876 (shown in FIG. 58) and a plurality of receptacles 878 (shown in FIG. 58). The plurality of receptacles 878 being positioned about the pivot axis A3 (shown in FIG. 56) and the at least one projection 876 being received in different ones of the receptacles 878 to vary the angular position of the pivotal backshell assembly 810. The angular retention arrangement 870 being resiliently movable in an orientation along the pivot axis between a first state in which the angular position of the pivotal backshell assembly 810 is adjustable and a second state in which the at least one projection 876 is received within a corresponding one of the receptacles 878 to lock the pivotal backshell assembly 810 in a selected one of the angular positions. The backshell body 820 and the cable management structure 840 include a mating pivot guide arrangement 830 (shown in FIG. 59) for guiding pivotal movement of the pivotal backshell assembly 810 movement about the pivot axis. The mating pivot guide arrangement may include a central pivot pin 832 (shown in FIG. 59) and a corresponding pivot pin opening 834 (shown in FIG. 59). The pivot guide arrangement 830 being unitarily integrated with the backshell body 820 and the cable management structure 840.

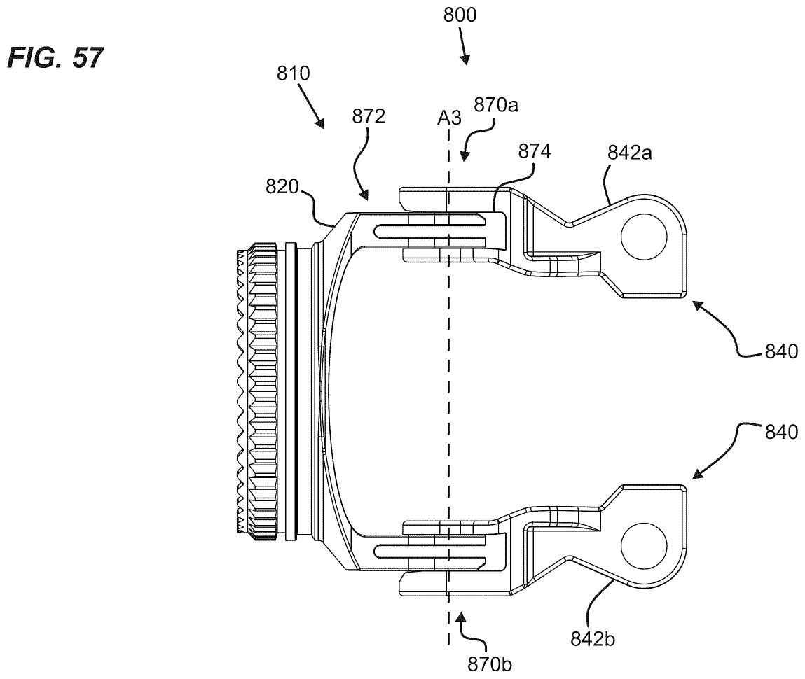

The cable management structure 840 includes the first and second separate attachment arms 842a, b (shown in FIGS. 56 and 58) that pivotally couple to the backshell body 820. The angular retention arrangement 870 includes a first angular retention arrangement 870a (shown in FIG. 56) between the first attachment arm 842a and the backshell body 820 and a second angular retention arrangement 870b (shown in FIG. 56) between the second attachment arm 842b and the backshell body 820. The first and second angular retention arrangements 870a, b each include an insertion portion 872 (shown best in FIG. 57) that fits within a receiver 874. The insertion portion 872 is defined by first and second extensions 872a, b (shown in FIG. 58) that fit within the receiver 874. Each of the receiver 874 and the first or second extensions 872a, b may include deflection surfaces which allow easier insertion of the extensions with the receiver 874. The first extension 872a and second extension 874b may be moved between the first and second states to allow the rotation of the backshell body 820 to different angular positions. For example, one of the first extensions 872a may be resiliently flexed toward the other of the first and second extensions 872a, b within the receiver 874 to move the corresponding one of the first and second angular retention arrangements 870a, b from the second state to the first state.

In the example embodiment, the first and second angular retention arrangements 870a, b each include a plurality of the projections 876 positioned about the pivot axis A3. The projections 876 are unitarily integrated with one of the first or second extensions 872a, b of each of the first and second angular retention arrangements 870a, b. Preferably, the projections 876 are integral with the first extension 872a.

Referring to FIGS. 58 and 59, each pivot guide arrangement 830 may include a central pivot pin 832. The central pivot pins 832 align with the pivot axis and are integrated unitarily with one of the first and second extensions 872a, b, of each of the first and second angular retention arrangements 870a, b. The central pivot pins 832 may have corresponding mating pivot pin openings 834 for receiving the central pivot pins 832 are defined within the receiver 874 of each arm 842a, b for each of the first and second angular retention arrangements 870a, b.

The plurality of projections 876 may be circumferentially surround the central pivot pin 832 around the pivot axis A3. The receptacles 878 are defined within the receivers 874 of each of the first and second angular retention arrangements. The receptacles 878 may circumferentially surrounded the central pivot pin openings 834 around the pivot axis A3. The receptacles 878 receive the projections 876 to retain the first extension in the second state. The central pivot pin opening 834 receives the central pivot pin 832 to guide rotation. As such, a different angular position of the pivotable backshell assembly 810 is formed when the receptacles 878 receive different projection 876. In the example embodiment, the first extension 872 may be deflected to allow the first and second extension 872a, b to be positioned within the receiver and placed in the second state. As such, the central pivot pin 832 may engage with the central pivot pin opening 834 of the first extension and the projection 876 may engage with the receptacles 878 to placing the cable management structure 840 within the second state. The first extension 872a may be deflected to adjust the angular position of the backshell body 820 relative to the cable management structure 840. When deflected, the first extension changes the angular position of the backshell body 820 by being pivoted to position the projection 876 within a different receptacle 878 at a different angular position.

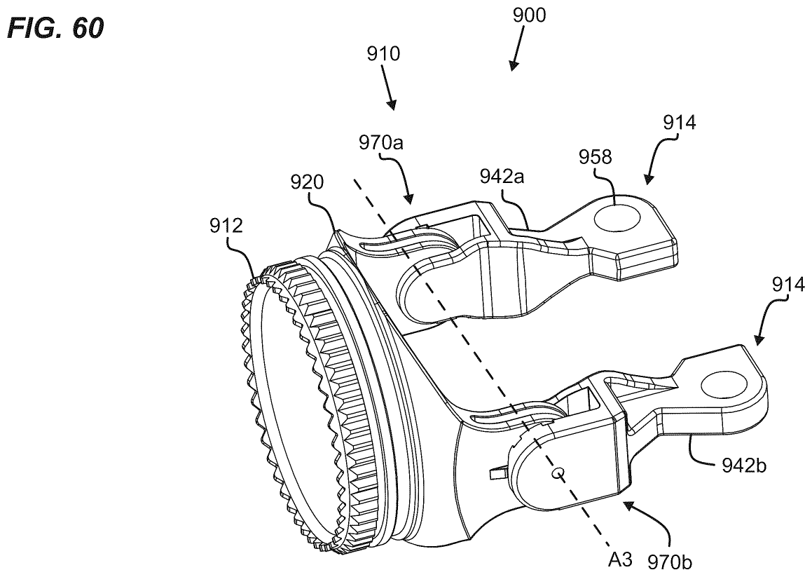

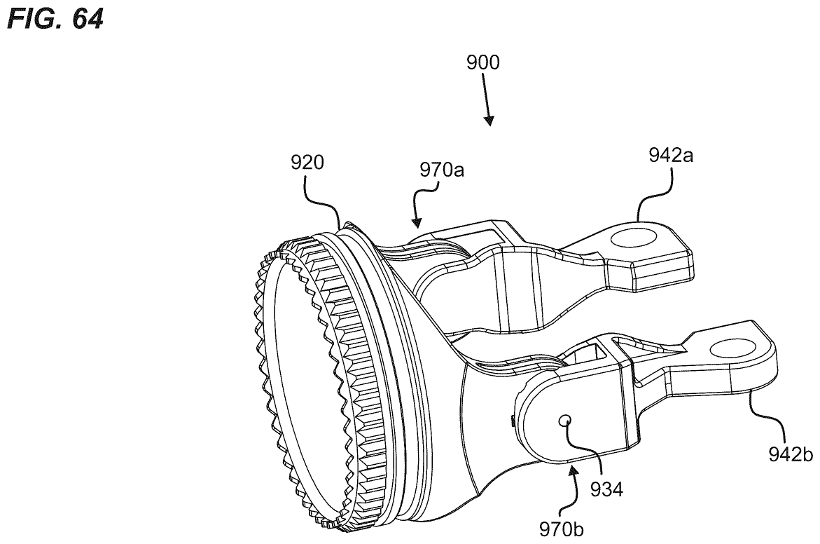

FIGS. 60-65 show another embodiment of the pivotal backshell device 900. Referring to FIG. 60, the example backshell device 900 may comprising a pivotal backshell assembly 910 having a first end 912 and a second end 914. The first end 912 is configured to connect to the connector and the second end 914 is configured to accommodate the cable. The first end 912 being defined by a backshell body 920 and the second end 914 being defined by a cable management structure 940. The backshell body 920 and cable management structure 940 being pivotally moveable about a pivot axis A3 relative to each other between a plurality of different angular positions. In some instances, the backshell body 920 may be an integrally formed unitary body. In present example, the cable management structure 940 is formed by first and second separate attachment arms 942a, b connected by a cable clamp 860 (shown in FIG. 56). In other examples, the cable management structure 940 may be formed by a single unitary body. The first and second attachment arms 942a, b each include an opening 958 for attachment of the cable clamp 860 via fasteners. The opening 958 may be positioned at the second end 914 of the pivotal backshell assembly 910.

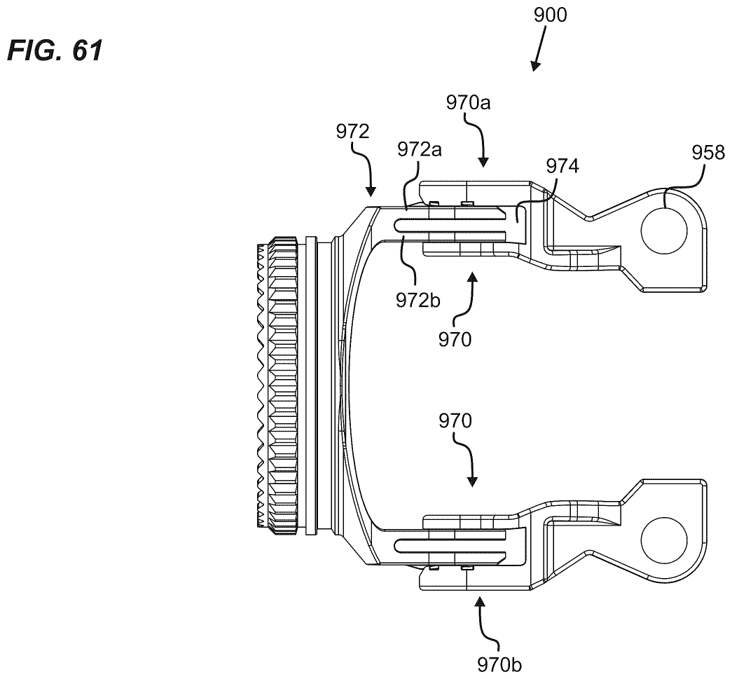

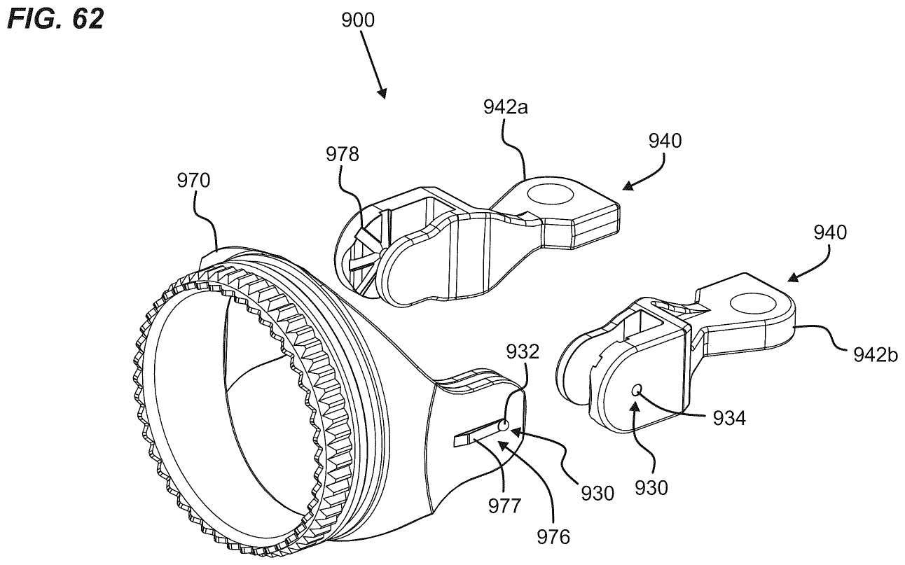

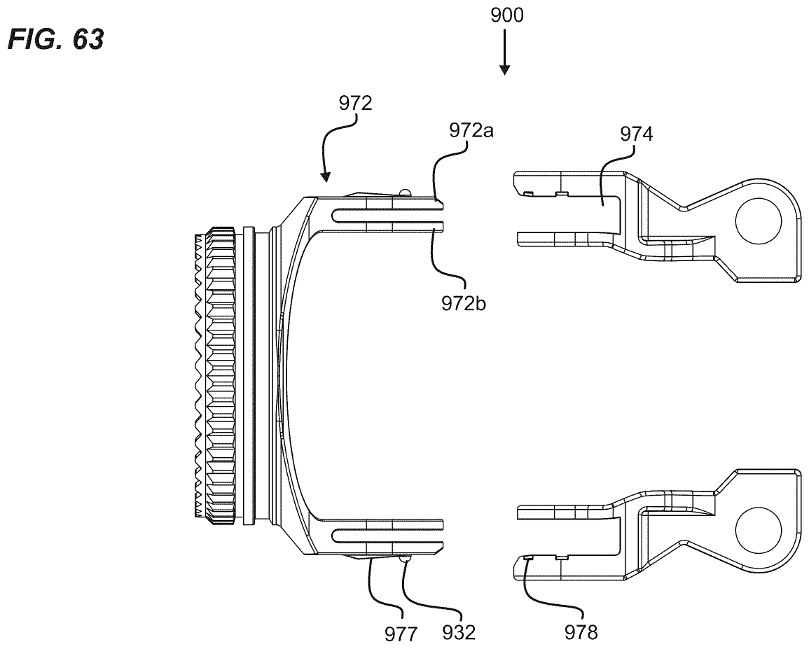

The pivotal backshell assembly 910 also includes an angular retention arrangement 970 for allowing the pivotal backshell assembly 910 to be set at a selected one of the different angular positions. Although discussed singularly, the pivotal backshell assembly 910 includes angular retention arrangements 970 on opposite sides of the assembly about the pivot axis A3. The angular retention arrangement 970 includes at least one projection 976 (shown in FIG. 62) and a plurality of receptacle 978 (shown in FIG. 62). The plurality of receptacles 978 being positioned about the pivot axis A3 (shown in FIG. 60) and the at least one projection 976 being received in different ones of the receptacles 978 to vary the angular position of the pivotal backshell assembly 910. The angular retention arrangement 970 being resiliently movable in an orientation along the pivot axis A3 between a first state (shown in FIG. 63) in which the angular position of the pivotal backshell assembly 910 is adjustable and a second state (shown in FIG. 61) in which the at least one projections 976 is received within a corresponding one of the receivers 974 (shown in FIG. 61) to lock the pivotal backshell assembly 910 in a selected one of the angular positions. The backshell body 920 and the cable management structure 940 include a mating pivot guide arrangement 930 for guiding pivotal movement of the pivotal backshell assembly 910 movement about the pivot axis. The pivot guide arrangement 930 being unitarily integrated with the backshell body 920 and the cable management structure 940.

In the present example, the cable management structure 940 includes the first and second separate attachment arms 942a, b (shown in FIGS. 61 and 63) that pivotally couple to the backshell body 920. The angular retention arrangement 970 includes a first angular retention arrangement 970a between the first attachment arm 942a and the backshell body 920 and a second angular retention arrangement 970b between the second attachment arm 942b and the backshell body 920. The first and second angular retention arrangements 970a, b, each include an insertion portion 972 (shown best in FIG. 61) that fits within a receiver 974 (shown in FIG. 63). Each of the receiver 974 and the first or second extensions 972a, b may include deflection surfaces which allow easier insertion of the insertion portion 972 with the receiver 974. The insertion portion 972 is defined by first and second extensions 972a (shown best in FIG. 63) that fit within the receiver 974. The first extension 972a and second extensions 972b may be moved between the first and second states to allow the rotation of the backshell body 920 to different angular positions. For example, one of the first extensions 972a may be resiliently flexed toward the other of the first and second extensions 972a, b within the receiver 974 to move the corresponding one of the first and second angular retention arrangements 970a, b from the second state to the first state.

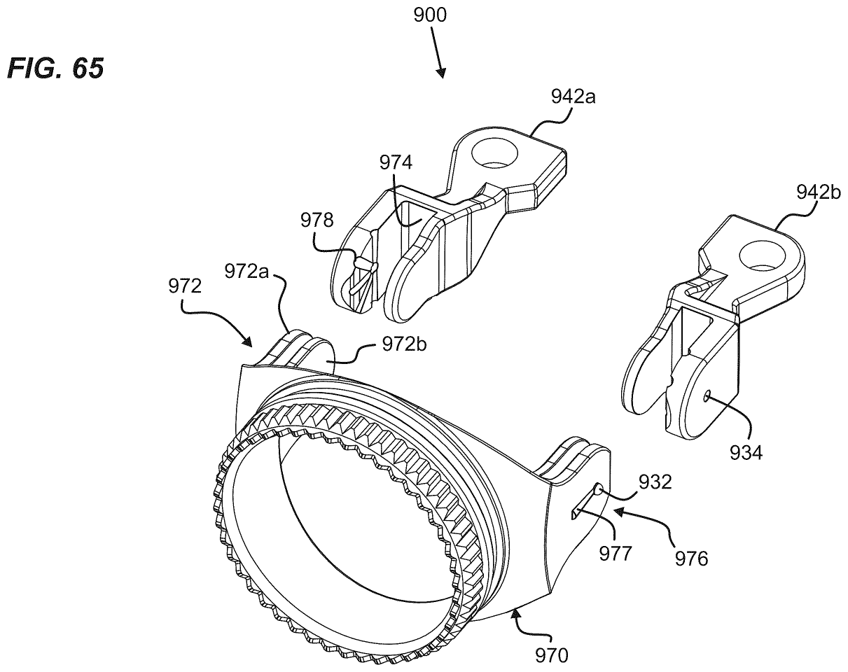

In the present example, the projections 976 of each of the first and second angular retention arrangements 970a, b includes a rib 977 (shown in FIG. 62) that extends radially outwardly from the pivot axis. The projections 976 are unitarily integrated with one of the first and second extensions 972a, b of each of the first and second angular retention arrangements 970a, b. Preferably, the projections 976 are integral with the first extension 972a. In some examples, the rib 977 may have rectangular transverse cross-sectional profile (shown in FIG. 62) and in other examples the rib 977 may have a rounded transverse cross-sectional profile (shown in FIG. 65). The receptacles 978 are radial slots defined within the receiver 974 of each of the first and second angular retention arrangements 970a, b. The radial slots may have a cross-sectional profile which match the cross-sectional profile of the rib 977. The pivot guide arrangement 930 includes central pivot pins 932 located at ends of the ribs 977 and aligned with the pivot axis A3 and integrated unitarily with one of the first and second extensions of each of the first and second angular retention arrangements. Further, mating pivot pin openings 934 for receiving the central pivot pins 932 are defined within the receiver 974 of each of the first and second angular retention arrangements.

In some examples, the central pivot pin 932 on an end of the rib 977 may prevent radial movement of rib 977 when received by the central pivot pin opening 934. The mating pivot pin openings 934 which receives the central pivot pins 932 of the rib 977. The plurality of receptacles 978 define the radial slots which receives the rib 977. As such, a length of the rib 977 received within the radial slots to set the first extension 972a of each angular retention arrangement 970 at a desired angular position and the central pivot pin 932 received in the pivot pin openings 934. Further in some examples, the first extension 972a may be resiliently flexed to move the rib 977 out of the receptacles 978 and central pivot pin 932 out of the central pivot pin opening 934 to change the angular position of the pivot backshell assembly 910.

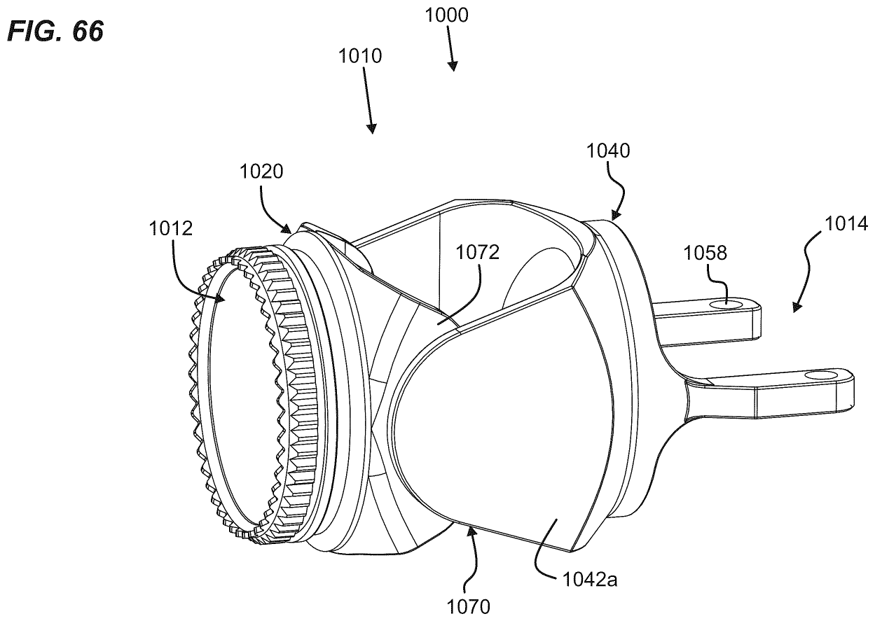

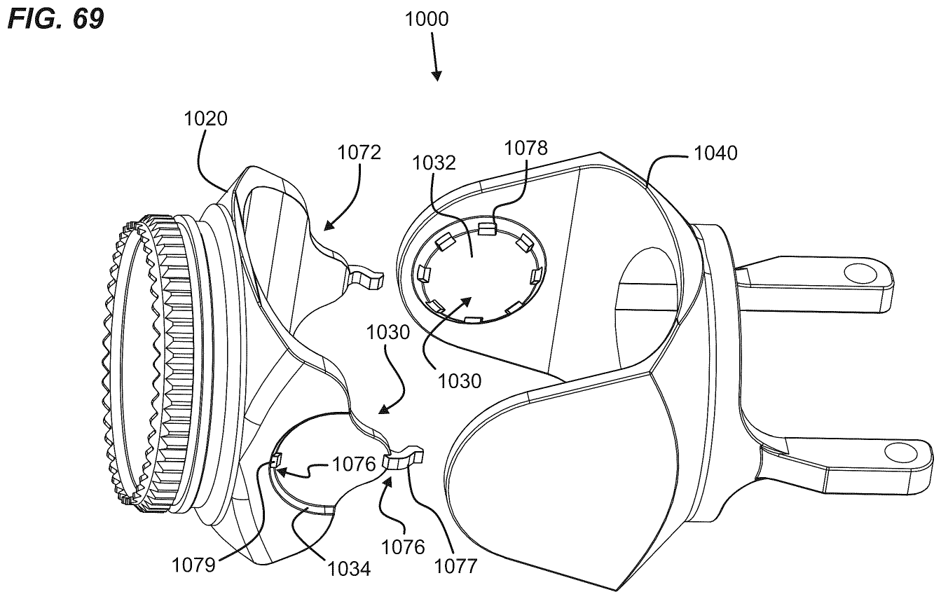

FIG. 66-69 illustrates another alternative embodiment of a pivotal backshell device 1000 of the present disclosure. The example backshell device 1000 may comprising a pivotal backshell assembly 1010 having a first end 1012 and a second end 1014. The first end 1012 is configured to connect to the connector and the second end 1014 is configured to accommodate the cable. The first end 1012 being defined by a backshell body 1020 and the second end 1014 being defined by a cable management structure 1040. The backshell body 1020 and cable management structure 1040 being pivotally moveable about a pivot axis A3 relative to each other between a plurality of different angular positions. In some instances, the backshell body 1020 may be an integrally formed unitary body. In present example, the cable management structure 1040 is formed by an integrally formed unitary body. In other examples, the cable management structure 1040 may be first and second separate attachment arms connected together by a cable clamp 860 (shown in FIG. 56). The cable management structure 1040 includes openings 1058 for attachment of the cable clamp 860 via fasteners. The openings 1058 may be positioned at the second end 1014 of the pivotal backshell assembly 1010.

The pivotal backshell assembly 1010 also includes an angular retention arrangement 1070 for allowing the pivotal backshell assembly 1010 to be set at a selected one of the different angular positions. Although discussed singularly, the pivotal backshell assembly 1010 includes angular retention arrangements 1070 on opposite sides of the assembly about the pivot axis. The angular retention arrangement 1070 includes at least one projection 1076 and a plurality of receptacles 1078. The plurality of receptacles 1078 being positioned about the pivot axis A3 and the at least one projection 1076 being received in different ones of the receptacles 1078 to vary the angular position of the pivotal backshell assembly 1010. The angular retention arrangement 1070 being resiliently movable in an orientation along the pivot axis A3 between a first state in which the angular position of the pivotal backshell assembly 1010 is adjustable and a second state in which the at least one projection 1076 is received within a corresponding one of the receptacles 1078 to lock the pivotal backshell assembly 1010 in a selected one of the angular positions. The backshell body 1020 and the cable management structure 1040 include a mating pivot guide arrangement 1030 for guiding pivotal movement of the pivotal backshell assembly 1010 movement about the pivot axis. The pivot guide arrangement 1030 being unitarily integrated with the backshell body 1020 and the cable management structure 1040. The pivot guide arrangement 1030 includes a disc 1032 aligned with the pivot axis A3 and integrated unitarily with one of the backshell body 1020 or the cable management structure 1040. Each of first and second attachment arms 1042a, b may define a disc 1032. The disc 1032 fits within a guide recess 1034 defined by the other of the backshell body 1020 or the cable management structure 1040. The receptacles 1078 are defined about a circumference of the disc 1032. For example, the backshell body 1020 include the guide recess 1034 and the cable management structure 1040 include the disc 1032.

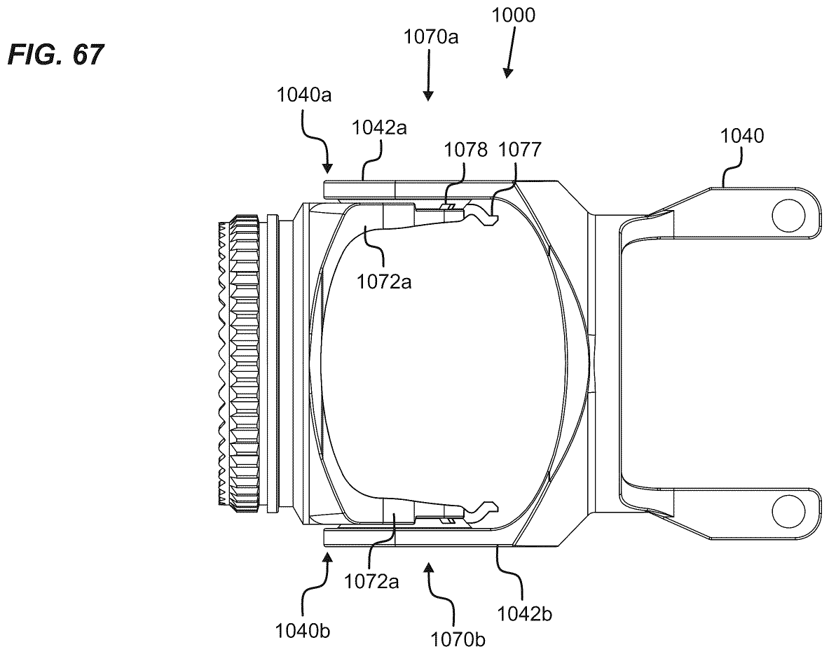

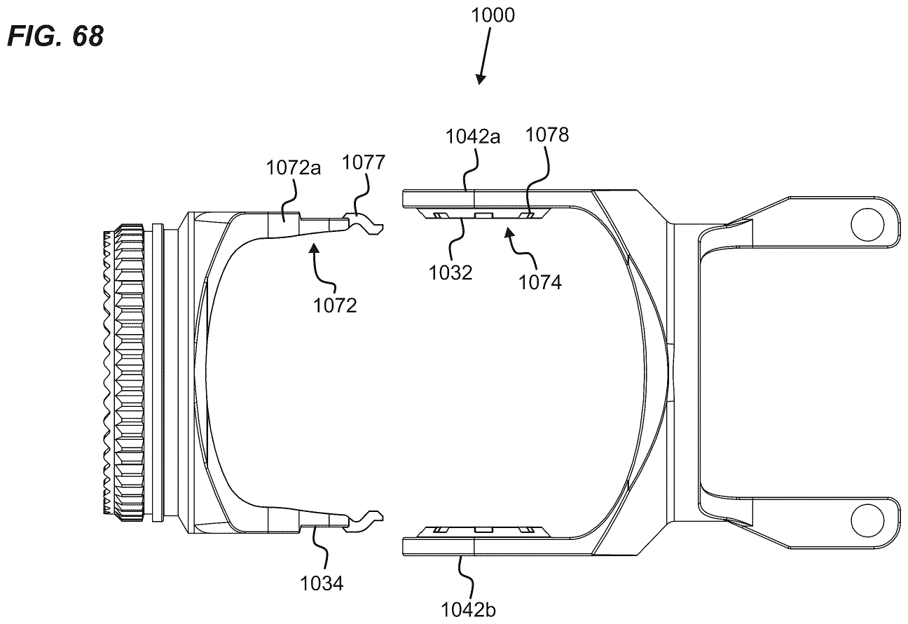

The cable management structure 1040 includes first and second attachment arms 1042a, b (shown in FIGS. 67 and 68) that pivotally couple to the backshell body 1020. The angular retention arrangement 1070 includes a first angular retention arrangement between the first attachment arm 1042a and the backshell body 1020 and a second angular retention arrangement 1040b between the second attachment arm 1042b and the backshell body 1020.

The first and second angular retention arrangements each include an insertion portion 1072 (shown best in FIG. 68) that fits within a receiver 1074. Each receiver 1074 may be defined by the first and second attachment arms 1042a, b. In the present example, the receiver 1074 is the disc 1032 which receives the first extension 1072a. The insertion portion 1072 may defined by a first extension 1072a (shown best in FIG. 68) that fits within the receiver 1074. The first extension 1072a may define the guide recess 1034 which receives the disc 1032 of respective first and second attachment arms 1042a, b. The first extension 1072a may be moved between the first and second states to allow the rotation of the backshell body 1020 to different angular positions. For example, the first extension 1072a may be resiliently flexed away from the receiver 1074 to move the corresponding one of the first and second angular retention arrangements 1070a, b from the second state to the first state.

Each first extension 1072 may include the projections 1076, which may be a resilient cantilever arm 1077. The first extension may include a protrusion 1079 aligned with resilient cantilever arm 1077 along a longitudinal axis of the backshell body 1020. The receptacles 1078 may defined around the circumference of the disc 1032 of each of the first and second attachment arms 1042a, b. One of the receptacles 1078 may receive the resilient cantilever arm and another receptacle may receive the protrusion to set the backshell body 1020 within the desired angular position. The resilient cantilever arm may be resiliently flexed away from the receptacles 1078 of the disc 1032 to pivot the first extension and change the angular position of the backshell body 1020 relative to the cable management structure 1040.

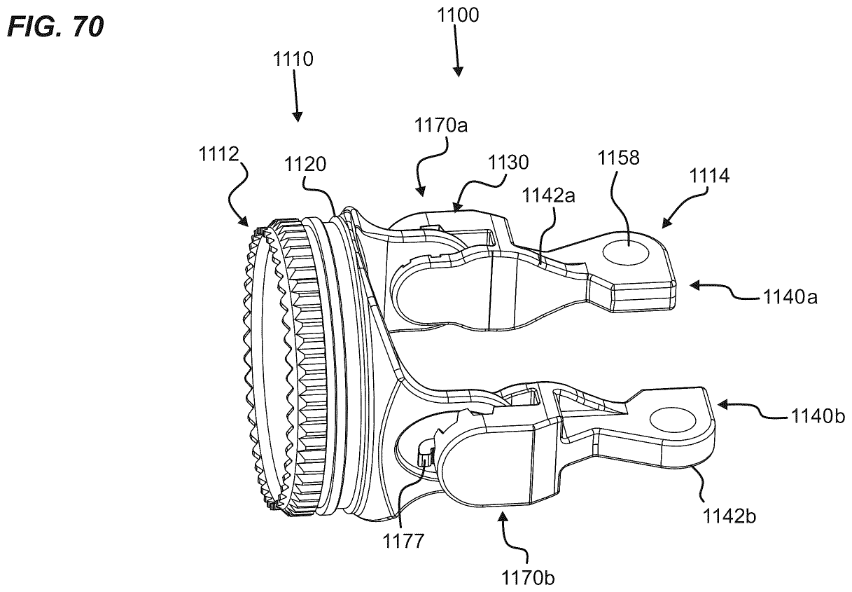

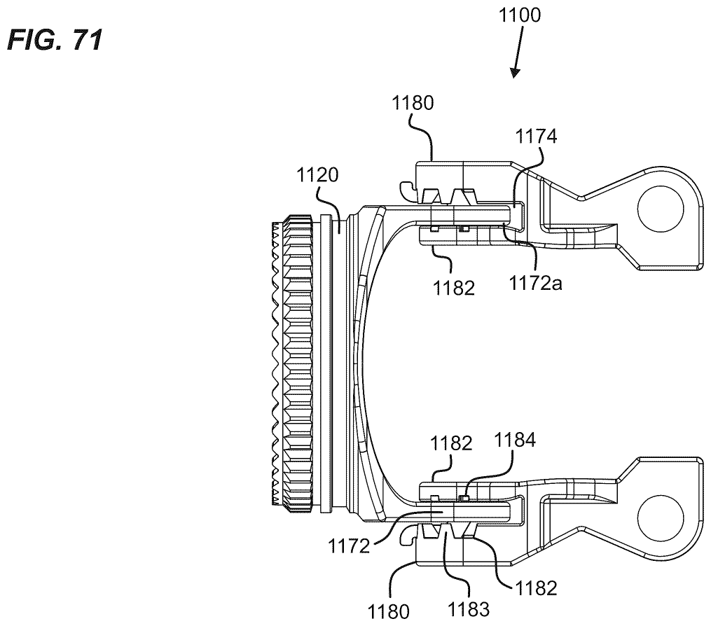

FIGS. 70-73 illustrates a further alternative embodiment of the pivotal backshell device 1100 of the present disclosure. The example backshell device 1100 may comprising a pivotal backshell assembly 1110 having a first end 1112 and a second end 1114. The first end 1112 is configured to connect to the connector and the second end 1114 is configured to accommodate the cable. The first end 1112 being defined by a backshell body 1120 and the second end 1114 being defined by a cable management structure 1140. The backshell body 1120 and cable management structure 1140 being pivotally moveable about a pivot axis A3 relative to each other between a plurality of different angular positions. In some instances, the backshell body 1120 may be an integrally formed unitary body. In present example, the cable management structure 1140 is formed by first and second separate attachment arms 1142a, b which are connected by a cable clamp 860 (shown in FIG. 56). In other examples, the cable management structure 1140 may be formed by a single unitary body. The first and second attachment arms 1142a, b each include an opening for attachment of the cable clamp 860 via fasteners. The opening 1158 may be positioned at the second end 1114 of the pivotal backshell assembly 1110.

The pivotal backshell assembly 1110 also includes an angular retention arrangement for allowing the pivotal backshell assembly 1110 to be set at a selected one of the different angular positions. Although discussed singularly, the pivotal backshell assembly 1110 includes angular retention arrangements on opposite sides of the assembly about the pivot axis. The angular retention arrangement includes at least one projection and a plurality of receptacles 1178. The plurality of receptacles 1178 being positioned about the pivot axis A3 and the at least one projection 1176 being received in different ones of the receptacles 1178 to vary the angular position of the pivotal backshell assembly 1110. The angular retention arrangement 1170 being resiliently movable in an orientation along the pivot axis A3 between a first state in which the angular position of the pivotal backshell assembly 1110 is adjustable and a second state in which the at least one projection 1176 is received within a corresponding one of the receptacles 1178 to lock the pivotal backshell assembly 1110 in a selected one of the angular positions. In some instances, the receptacles 1178 may be a first and second set of receptacles 1184,1186. The backshell body 1120 and the cable management structure 1140 include a mating pivot guide arrangement 1130 for guiding pivotal movement of the pivotal backshell assembly 1110 movement about the pivot axis. The pivot guide arrangement 1130 being unitarily integrated with the backshell body 1120 and the cable management structure 1140.

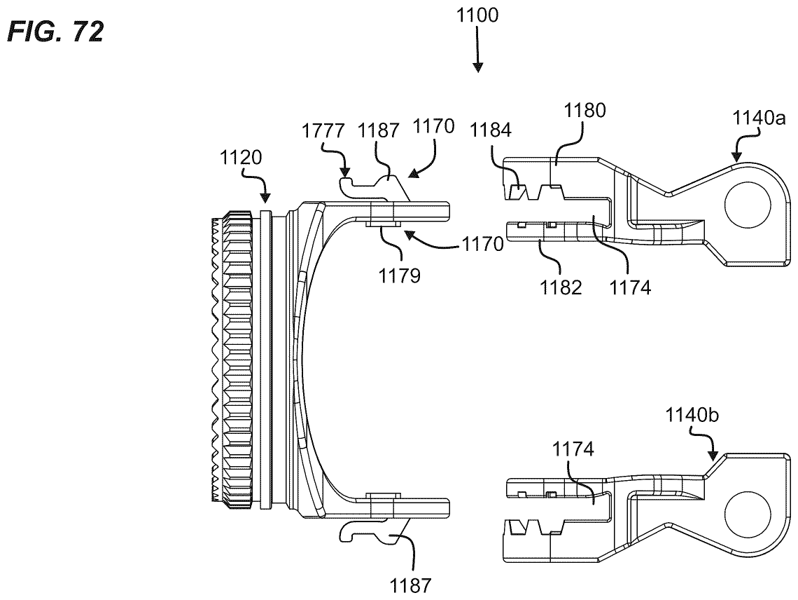

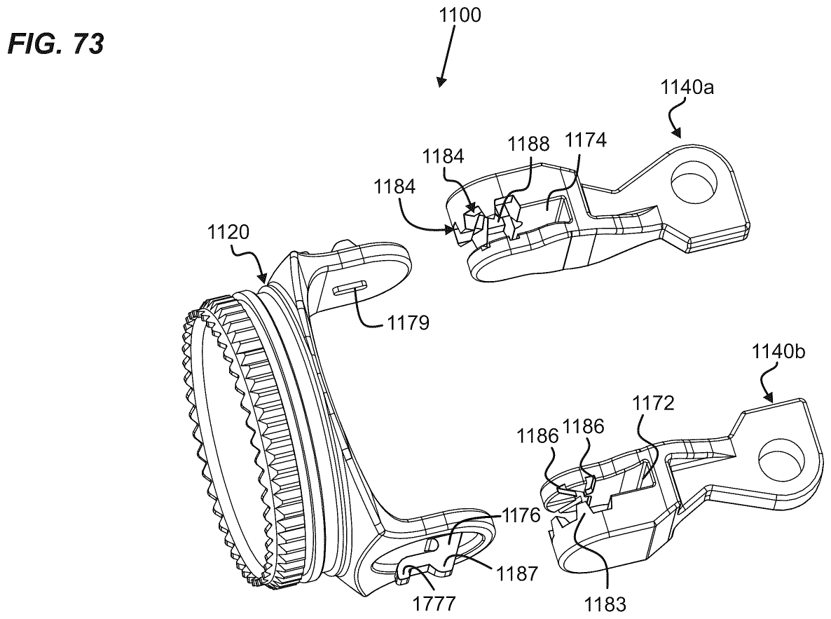

In the present example, the cable management structure 1140 includes the first and second separate attachment arms 1142a, b that pivotally couple to the backshell body 1120. The angular retention arrangement includes a first angular retention arrangement 1140a between the first attachment arm 1142a and the backshell body 1120 and a second angular retention arrangement 1140b between the second attachment arm 1142b and the backshell body 1120. The first and second angular retention arrangements 1140a, b, each include an insertion portion 1172 that fits within a receiver 1174. The insertion portion 1172 may also define a guide recess on a first side. The insertion portion 1172 may define a first extension 1172a that fits within the receiver 1174. The projections 1176 of each of the first and second retention arrangements 1170 includes a flexible cantilever 1177 unitarily integrated with each insertion portion 1172, and the receptacles 1178 include radial slots defined within the receiver 1174. The flexible cantilever 1177 unitarily integrated with each insertion point may be a tab. The insertion portion 1172 may also include a protrusion 1179 on a side opposite the first side and the flexible cantilever 1177. Each receiver 1174 may include a first receiver wall 1180 and a second receiver wall 1182. The first receiver walls 1180 include teeth 1183 which define a first set of receptacles 1184 which may receive the flexible cantilever 1177. The teeth 1183 may be spaced around an interior side of each of the first receiver walls 1180. The second receiver wall 1182 defines a second set of receptacles 1186. The second set of receptacles 1186 being the radial slots which receive the protrusion 1179. The pivot arrangement 1130 includes the flexible cantilever 1177 and a central receptacle 1188. The flexible cantilever may further include a ridge 1187 (shown in FIGS. 72 and 73) being receivable within a central receptacle 1188 (shown in FIG. 73) on the first receiver wall 1180. The central receptacle 1188 may circumferentially surrounded by the first set of receptacles 1184. The flexible cantilever may be inserted within the receiver 1174 within one of the first set of receptacles 1178 and the protrusion 1179 is received within one the radial slots on the second receiver wall to place the assembly within the second state. The assembly may be move to the unlocked state by deflecting the flexible cantilever and ridge 1187 out of respective receptacles 1184 and 1188. As such the first extension 1172a may be pivoted to adjust the angular position of the backshell body 1120 by inserting the flexible cantilever 1177 and protrusion 1179 within a different respective receptacle and radial slot.

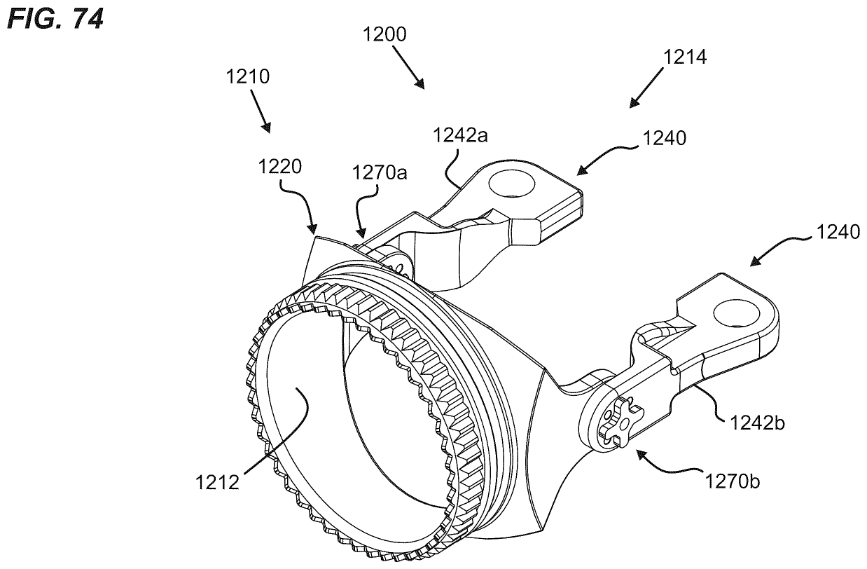

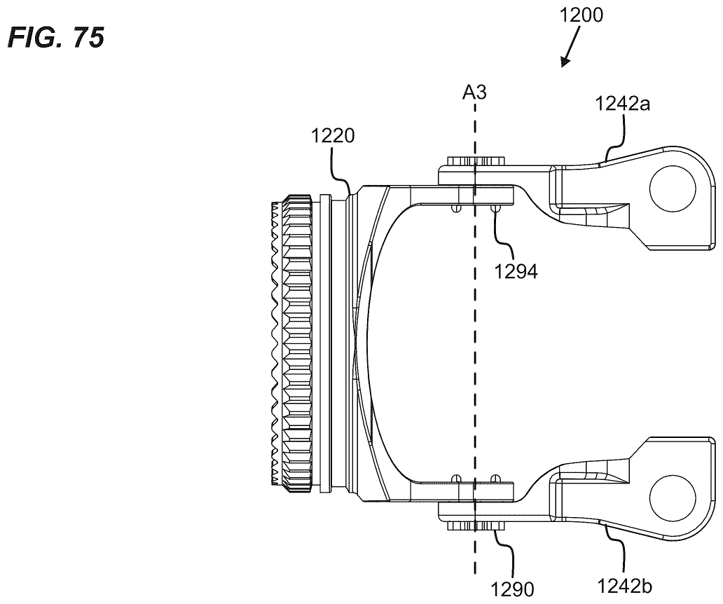

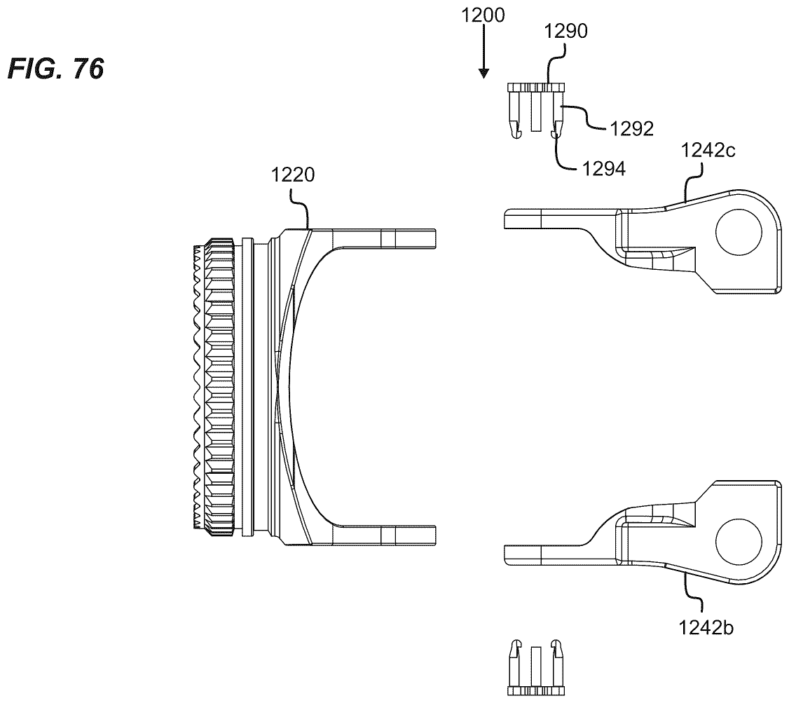

FIGS. 74-77 illustrate another alternative embodiment to the pivotal backshell device 1200. The pivotal backshell device provides a connection to a connector to provide strain relief and bend control of a cable connected to the connector. The backshell device includes a pivotal backshell assembly 1210 having a first end 1212 and a second end 1214. The first end 1212 being configured for connection to the connector and the second end 1214 being configured to accommodate the cable. The first end 1212 being defined by a backshell body 1220 and the second end 1214 being defined by a cable management structure 1240. The backshell body 1220 and cable management structure 1240 being pivotally moveable about a pivot axis A3 (shown best in FIG. 75) relative to each other between a plurality of different angular positions. In some instances, the backshell body 1220 may be an integrally formed unitary body. In present example, the cable management structure 1240 is formed by first and second separate attachment arms 1242a, b which are connected by a cable clamp 860 (shown in FIG. 56). In other examples, the cable management structure 1240 may be formed by a single unitary body. The first and second attachment arms 1242a, b each include an opening for attachment of the cable clamp 860 via fasteners. The opening may be positioned at the second end 1214 of the pivotal backshell assembly 1210.

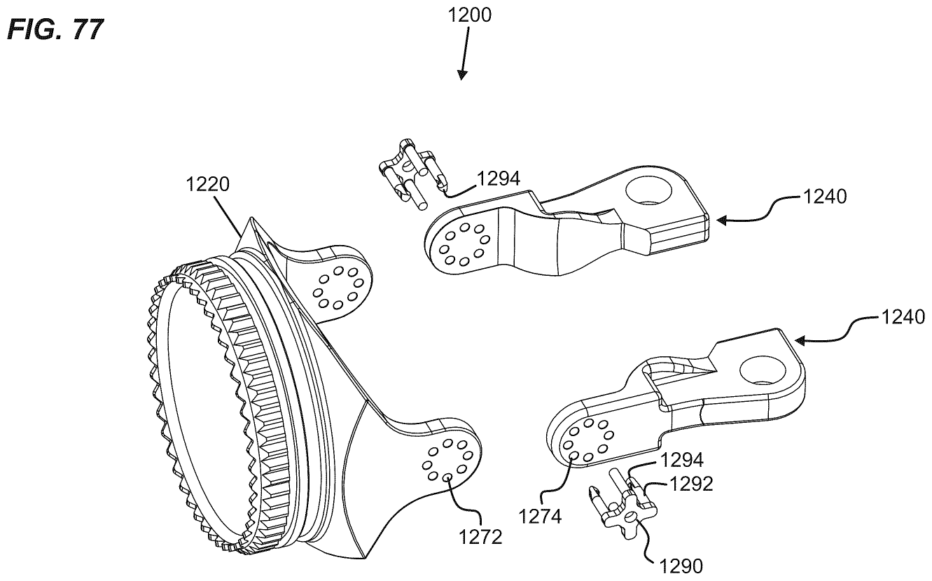

The pivotal backshell assembly 1210 includes an angular retention arrangement for allowing the pivotal backshell assembly 1210 to be set at a selected one of the different angular positions. The angular retention arrangement including a first set of openings 1272 (shown in FIG. 77) defined by the backshell body 1220 about the pivot axis A3 and a second set of openings (shown in FIG. 77) defined by the cable management structure 1240 about the pivot axis A3 (shown in FIG. 74). The openings of the first and second sets of openings 1272,1274 align with each other when the pivotal backshell assembly 1210 is in the different angular positions. In some examples, the backshell body 1220 may align on an interior side of the assembly relative to the cable management structure 1240. In other examples, the backshell body 1220 may align on an exterior side of the assembly relative to the cable management structure 1240.

The backshell device may also include a locking hub 1290. The locking hub including a plurality of pins 1292 that extend through the aligned sets of first and second openings 1272, 1274 to lock the pivotal backshell assembly 1210 in a selected angular position. The locking hub 1290 may be held within the openings by a snap-fit connection. Additionally, the plurality of pins 1292 may include hooked regions 1294 which hold locking hub against one of the backshell body 1220 or the cable management structure 1240. The locking hub 1290 may be removed from the snap-fit configuration by deflecting the hooked region 1294 to allow removal of the pins 1292 from the aligned first and second openings 1272,1274.

When the locking hub 1290 is removed from the aligned sets of first and second openings 1272,1274, the backshell body 1220 may be rotated to align the first set of openings 1272 with different respective openings of the second set of openings 1274. The locking hub 1290 may be inserted through the new alignment of the first set of openings 1272 and second set of openings 1294 to fix the backshell assembly 1210 in a different angular position.

One aspect of the invention is to provide an assembly which can be configured in multiple positions to allow the guiding of wires to a coupler at various angles such as a straight position, a right-angle position, or a plurality of intermediate angle positions. By providing a design capable of multiple angular positions for guiding wires, the assembly may simplify the assembly process.

One aspect of the invention is to reduce the risk of foreign object debris (FOB) at the time of angle reposition. The assembly does not have to be separated in order to change angular positions, so the likelihood of parts being accidentally left behind when reconfiguring the angle of the assembly may be reduced, and the likelihood of damage to wires may be decreased.

Another aspect of the disclosure is to simplify manufacturing process steps by utilizing additive manufacturing. By utilizing additive manufacturing, the number of steps may be reduced to manufacture the product. The product may be manufactured as a single piece. The single piece may than be divided into the individual pieces to complete the manufacture of the device and to allow movability between the parts. Additionally, the possibility of incorrect assembly may be reduced by additive manufacturing the assembly as a single piece with parts being subsequently divided to allow movability between the parts without requiring the parts to be un-joined when changing the angular position.

The various examples described above are provided by way of illustration only and should not be construed to limit the scope of the present disclosure. Those skilled in the art will readily recognize various modifications and changes that may be made without following the examples and applications illustrated and described herein, and without departing from the true spirit and scope of the present disclosure.

### ASPECTS OF THE PRESENT DISCLOSURE

Aspect 1. A backshell device for connection to a connector to provide strain relief and bend control of a cable connected to the connector, the backshell device comprising:
   a pivotal backshell assembly having a first end and a second end, the first end being configured for connection to the connector and the second end being configured to accommodate the cable, the first end being defined by a backshell body and the second end being defined by a cable management structure, the backshell body and cable management structure being pivotally moveable about a pivot axis relative to each other between a plurality of different angular positions; and
   the pivotal backshell assembly including an angular retention arrangement for allowing the pivotal backshell assembly to be set at a selected one of the different angular positions, the angular retention arrangement including at least one projection and a plurality of receptacles, the plurality of receptacles being positioned about the pivot axis, the at least one projection being received in different ones of the receptacles to vary the angular position of the pivotal backshell assembly, the angular retention arrangement being resiliently movable in an orientation along the pivot axis between a first state in which the angular position of the pivotal backshell assembly is adjustable and a second state in which the at least one projection is received within a corresponding one of the receptacles to lock the pivotal backshell assembly in a selected one of the angular positions, and wherein the backshell body and the cable management structure include a mating pivot guide arrangement for guiding pivotal movement of the pivotal backshell assembly about the pivot axis, the pivot guide arrangement being unitarily integrated with the backshell body and the cable management structure.
Aspect 2. The backshell device of aspect 1, wherein the angular retention arrangement is resiliently biased toward the second state by a construction of the backshell body and/or a construction of the cable management structure.
Aspect 3. The backshell device of aspect 1 or 2, wherein the angular retention arrangement is resiliently biased toward the first state by a construction of the backshell body and/or a construction of the cable management structure, and wherein a retainer is used retain the angular retention arrangement in the second state.
Aspect 4. The backshell device of aspects 1-3, wherein the cable management structure includes a socket, wherein the backshell body includes a ball that fits within the socket, and wherein the angular retention arrangement is defined between the ball and the socket.
Aspect 5. The backshell device of aspects 1-4, wherein the pivot guide arrangement includes an annular ring that fits within an annular recess, wherein the annular ring is defined by one of the ball or the socket and the annular recess is defined by the other of the ball and the socket, and wherein the annular retention is integrated with the annular ring and the annular recess.
Aspect 6. The backshell device of aspects 1-5, wherein the cable management structure includes a sleeve.
Aspect 7. The backshell device of aspects 1-6, wherein the cable management structure includes a cable clamp mount.
Aspect 8. The backshell device of aspects 1-7, wherein the cable clamp mount includes first and second attachment arms integrated into one piece.
Aspect 9. The backshell device of aspects 1-8, wherein the cable management structure includes first and second separate attachment arms that pivotally couple to the backshell body, wherein the angular retention arrangement includes a first angular retention arrangement between the first attachment arm and the backshell body and a second angular retention arrangement between the second attachment arm and the backshell body, wherein the first and second angular retention arrangements each include an insertion portion that fits within a receiver, wherein the insertion portion is defined by first and second extensions that fit within the receiver, and wherein one of the first extensions is resiliently flexed toward the other of the first and second extensions within the receiver to move the corresponding one of the first and second angular retention arrangements from the second state to the first state.
Aspect 10. The backshell device of aspects 1-9, wherein the first and second angular retention arrangements each include a plurality of the projections positioned about the pivot axis, wherein the projections are unitarily integrated with one of the first and second extensions of each of the first and second angular retention arrangements, and wherein the receptacles are defined within the receivers of each of the first and second angular retention arrangements.
Aspect 11. The backshell device of aspects 1-10, wherein the pivot guide arrangement includes central pivot pins aligned with the pivot axis and integrated unitarily with one of the first and second extensions of each of the first and second angular retention arrangements, and wherein mating pivot pin openings for receiving the central pivot pins are defined within the receivers of each of the first and second angular retention arrangements.
Aspect 12. The backshell device of aspects 1-11, wherein the projection of each of the first and second angular retention arrangements includes a rib that extends radially outwardly from the pivot axis, wherein the projections are unitarily integrated with one of the first and second extensions of each of the first and second angular retention arrangements, and wherein the receptacles are radial slots defined within the receivers of each of the first and second angular retention arrangements.
Aspect 13. The backshell device of aspects 1-12, wherein the pivot guide arrangement includes central pivot pins located at ends of the ribs and aligned with the pivot axis and integrated unitarily with one of the first and second extensions of each of the first and second angular retention arrangements, and wherein mating pivot pin openings for receiving the central pivot pins are defined within the receivers of each of the first and second angular retention arrangements.
Aspect 14. The backshell device of aspects 1-13, wherein the ribs have a rectangular transverse cross-sectional profile.
Aspect 15. The backshell device of aspects 1-14, wherein the ribs have a rounded transverse cross-sectional profile.
Aspect 16. The backshell device of aspects 1-15, wherein the cable management structure includes first and second attachment arms integrated into one piece, and wherein the projection includes a resilient cantilever arm.
Aspect 17. The backshell of aspects 1-16, wherein the pivot guide arrangement includes a disc aligned with the pivot axis and integrated unitarily with one of the backshell body or the cable management structure, wherein the disc fits within a guide recess defined by the other of the backshell body or the cable management structure, and wherein the receptacles are defined about a circumference of the disc.
Aspect 18. The backshell device of aspects 1-17, wherein the cable management structure includes first and second separate attachment arms that pivotally couple to the backshell body, wherein the angular retention arrangement includes a first angular retention arrangement between the first attachment arm and the backshell body and a second angular retention arrangement between the second attachment arm and the backshell body, wherein the first and second angular retention arrangements each include an insertion portion that fits within a receiver, wherein the projection of each of the first and second retention arrangements includes a flexible cantilever unitarily integrated with each insertion portion, and wherein the receptacles include radial slots defined within the recievers.
Aspect 19. A backshell device for connection to a connector to provide strain relief and bend control of a cable connected to the connector, the backshell device comprising:
   a pivotal backshell assembly having a first end and a second end, the first end being configured for connection to the connector and the second end being configured to accommodate the cable, the first end being defined by a backshell body and the second end being defined by a cable management structure, the backshell body and cable management structure being pivotally moveable about a pivot axis relative to each other between a plurality of different angular positions; and
   the pivotal backshell assembly including an angular retention arrangement for allowing the pivotal backshell assembly to be set at a selected one of the different angular positions, the angular retention arrangement including a first set of openings defined by the backshell body about the pivot axis and a second set of openings defined by the cable management structure about the pivot axis, the openings of the first and second sets of openings aligning with each other when the pivotal backshell assembly is in the different angular positions; and
   a locking hub including a plurality of pins that extend through the aligned sets of first and second openings to lock the pivotal backshell assembly in a selected angular position, the locking hub being held within the openings by a snap-fit connection.
Aspect 20. A device for receiving one or more cable structures, the device comprising:
   an assembly having a first end and a second end, the assembly defining a passage that extends through the assembly from the first end to the second end for receiving the one or more cable structures, the first end defining a first end axis and the second end defining a second end axis, the assembly being pivotally adjustable about a pivot axis to adjust an angle defined between the first end axis and the second end axis;
   the assembly including a first body defining the first end of the assembly, the first body including a ball through which the passage extends, the first body also including a first passage-defining portion that extends along the first end axis from the ball to the first end of the assembly;
   the assembly including a second body defining the second end of the assembly, the second body including a socket structure that mounts over the ball of the first body, the second body also including a second passage-defining portion that extends along the second end axis from the socket structure to the second end of the assembly, the socket structure and the ball defining a pivot interface when the socket structure is mounted over the ball, the pivot interface being adapted to allow relative pivotal movement between the first and second bodies about the pivot axis for allowing adjustment of the angle defined between the first and second end axes of the assembly, the second body defining a socket expansion slot that extends through a portion of the second passage-defining portion of the second body, the socket expansion slot being configured to allow the socket structure to expand;
   the assembly including an angular retention arrangement defined between the ball and the socket structure for setting the assembly in a plurality of different angular positions, wherein the angle defined between the first and second end axes of the assembly is different at each angular position of the assembly; and
   a locking mechanism for setting the assembly in a locked state in which expansion of the socket structure is limited such that the assembly is locked in a selected one of the angular positions, and wherein when the assembly is not in the locked state the angular position of the assembly can be adjusted about the pivot axis.
Aspect 21. The device of claim 1, wherein the angular positions of the assembly include an in-line position and a right-angle position.
Aspect 22. The device of aspect 21, wherein the angular positions include a plurality of intermediate angular positions between the in-line position and the right-angle position.
Aspect 23. The device of aspects 20-22, wherein the angular retention arrangement surrounds the pivot axis.
Aspect 24. The device of aspects 20-23, wherein the socket expansion slot extends into the socket structure.
Aspect 25. The device of aspects 20-24, wherein the socket expansion slot includes an end that opens into an angular adjustment slot defined by the socket structure, wherein the first body projects through the angular adjustment slot.
Aspect 26. The device of aspects 20-25, wherein the angular adjustment slot has a length that extends circumferentially about the pivot axis, and wherein ends of the angular adjustment slot define a range of pivotal movement allowed between the first and second bodies.
Aspect 27. The device of aspects 20-26, where the socket expansion slot includes first and second socket expansion slots positioned on diametrically opposite sides of the second passage-defining portion, the first and second socket expansion slots being aligned along a reference plane oriented perpendicular to the pivot axis.
Aspect 28. The device of aspects 20-27, wherein the angular retention arrangement includes a plurality of angular retention projections carried by one of the ball or the socket structure, and plurality of angular retention receptacles carried by the other of the ball or the socket structure, wherein the angular retention projections are adapted to be received within the angular retention receptacles, and wherein the angular retention projections and the angular retention receptacles are spaced about the pivot axis.
Aspect 29. The device of aspects 20-28, wherein one of the ball or the socket structure defines a ring, and the other of the ball and the socket structure defines an annular groove that receive the ring, the ring and the annular groove being co-axial with the pivot axis.
Aspect 30. The device of aspects 20-29, wherein the angular retention projections are defined by inserts installed within openings defined by the socket structure.
Aspect 31. The device of aspects 20-30, wherein the ball includes toothed sections that fit in the openings and engage the angular retention projections, and the inserts include snaps which engage the toothed sections when in the locked state.
Aspect 32. The device of aspects 20-31, wherein the locking mechanism comprises a locking band and at least one helical cut positioned circumferentially around the second passage-defining portion.
Aspect 33. The device of aspects 20-32, wherein the locking mechanism comprises a locking strap which tightens around the second passage-defining portion.
Aspect 34. The device of aspects 20-33, wherein the locking mechanism comprises a locking band with an L-shaped cutout and at least one peg positioned on the second passage-defining portion, wherein the peg is inserted into an end of the L-shaped cutout.
Aspect 35. The device of aspects 20-34, wherein the socket expansion slot extends through a cable attachment flange provided at the second end of the assembly, and wherein the locking mechanism includes a fastener adapted to engage attachment flange.
Aspect 36. The device of aspects 20-35, wherein the pivot interface is configured to allow adjustment of the angle between the first end axis and the second end axis is at least 225 degrees.
Aspect 37. The device of aspects 20-36, wherein the pivot interface is configured to allow adjustment of the angle between the first end axis and the second end axis is at least 315 degrees.
Aspect 38. The device of aspects 20-37, wherein the angular retention arrangement includes projection receptacles positioned in the annular groove and retention projections positioned on the ring.

What is claimed is:

1. A backshell device for connection to a connector to provide strain relief and bend control of a cable connected to the connector, the backshell device comprising:
a pivotal backshell assembly having a first end and a second end, the first end being configured for connection to the connector and the second end being configured to accommodate the cable, the first end being defined by a backshell body and the second end being defined by a cable management structure, wherein the backshell body and the cable management structure are pivotally moveable about a pivot axis relative to each other between a plurality of different angular positions; and
the pivotal backshell assembly including an angular retention arrangement for allowing the pivotal backshell assembly to be set at a selected one of the different angular positions, the angular retention arrangement including at least one projection and a plurality of receptacles, the plurality of receptacles being positioned about the pivot axis, the at least one projection being received in different ones of the receptacles to vary the angular position of the pivotal backshell assembly, the angular retention arrangement being resiliently movable in an orientation along the pivot axis between a first state in which the angular position of the pivotal backshell assembly is adjustable and a second state in which the at least one projection is received within a corresponding one of the receptacles to lock the pivotal backshell assembly in a selected one of the angular positions, and wherein the backshell body and the cable management structure include a mating pivot guide arrangement for guiding pivotal movement of the pivotal backshell assembly about the pivot axis, the pivot guide arrangement being unitarily integrated with the backshell body and the cable management structure.

2. The backshell device of claim 1, wherein the angular retention arrangement is resiliently biased toward the second state by a construction of the backshell body and/or a construction of the cable management structure.

3. The backshell device of claim 1, wherein the angular retention arrangement is resiliently biased toward the first state by a construction of the backshell body and/or a construction of the cable management structure, and wherein a retainer is used retain the angular retention arrangement in the second state.

4. The backshell device of claim 1, wherein the cable management structure includes a socket, wherein the backshell body includes a ball that fits within the socket, and wherein the angular retention arrangement is defined between the ball and the socket.

5. The backshell device of claim 4, wherein the pivot guide arrangement includes an annular ring that fits within an annular recess, wherein the annular ring is defined by one of the ball or the socket and the annular recess is defined by the other of the ball and the socket, and wherein the annular retention arrangement is integrated with the annular ring and the annular recess.

6. The backshell device of claim 1, wherein the cable management structure includes a sleeve.

7. The backshell device of claim 1, wherein the cable management structure includes a cable clamp mount.

8. The backshell device of claim 7, wherein the cable clamp mount includes first and second attachment arms integrated into one piece.

9. The backshell device of claim 8, wherein the cable management structure includes first and second separate attachment arms that pivotally couple to the backshell body, wherein the angular retention arrangement includes a first angular retention arrangement between the first attachment arm and the backshell body, and a second angular retention arrangement between the second attachment arm and the backshell body, wherein the first and second angular retention arrangements each include an insertion portion that fits within a receiver, wherein the insertion portion is defined by first and second extensions that fit within the receiver, and wherein one of the first extensions is resiliently flexed toward the other of the first and second extensions within the receiver to move the corresponding one of the first and second angular retention arrangements from the second state to the first state.

10. The backshell device of claim 9, wherein the first and second angular retention arrangements each include a plurality of the projections positioned about the pivot axis, wherein the projections are unitarily integrated with one of the first and second extensions of each of the first and second angular retention arrangements, and wherein the receptacles are defined within the receivers of each of the first and second angular retention arrangements.

11. The backshell device of claim 10, wherein the pivot guide arrangement includes central pivot pins aligned with the pivot axis and integrated unitarily with one of the first and second extensions of each of the first and second angular retention arrangements, and wherein mating pivot pin openings for receiving the central pivot pins are defined within the receivers of each of the first and second angular retention arrangements.

12. The backshell device of claim 9, wherein the projection of each of the first and second angular retention arrangements includes a rib that extends radially outwardly from the pivot axis, wherein the projections are unitarily integrated with one of the first and second extensions of each of the first and second angular retention arrangements, and wherein the receptacles are radial slots defined within the receivers of each of the first and second angular retention arrangements.

13. The backshell device of claim 12, wherein the pivot guide arrangement includes central pivot pins located at ends of the ribs and aligned with the pivot axis and integrated unitarily with one of the first and second extensions of each of the first and second angular retention arrangements, and wherein mating pivot pin openings for receiving the central pivot pins are defined within the receivers of each of the first and second angular retention arrangements.

14. The backshell device of claim 12, wherein the ribs have a rectangular transverse cross-sectional profile.

15. The backshell device of claim 12, wherein the ribs have a rounded transverse cross-sectional profile.

16. The backshell device of claim 1, wherein the cable management structure includes first and second attachment arms integrated into one piece, and wherein the projection includes a resilient cantilever arm.

17. The backshell device of claim 16, wherein the pivot guide arrangement includes a disc aligned with the pivot axis and integrated unitarily with one of the backshell body or the cable management structure, wherein the disc fits within a guide recess defined by the other of the backshell body or the cable management structure, and wherein the receptacles are defined about a circumference of the disc.

18. The backshell device of claim 1, wherein the cable management structure includes first and second separate attachment arms that pivotally couple to the backshell body, wherein the angular retention arrangement includes a first angular retention arrangement between the first attachment arm and the backshell body and a second angular retention arrangement between the second attachment arm and the backshell body, wherein the first and second angular retention arrangements each include an insertion portion that fits within a receiver, wherein the projection of each of the first and second retention arrangements includes a flexible cantilever unitarily integrated with each insertion portion, and wherein the receptacles include radial slots defined within the receivers.

19. A backshell device for connection to a connector to provide strain relief and bend control of a cable connected to the connector, the backshell device comprising:
a pivotal backshell assembly having a first end and a second end, the first end being configured for connection to the connector and the second end being configured to accommodate the cable, the first end being defined by a backshell body and the second end being defined by a cable management structure, wherein the backshell body and the cable management structure being pivotally moveable about a pivot axis relative to each other between a plurality of different angular positions; and
the pivotal backshell assembly including an angular retention arrangement for allowing the pivotal backshell assembly to be set at a selected one of the different angular positions, the angular retention arrangement including a first set of openings defined by the backshell body about the pivot axis and a second set of openings defined by the cable management structure about the pivot axis, the openings of the first and second sets of openings aligning with each other when the pivotal backshell assembly is in the different angular positions; and
a locking hub including a plurality of pins that extend through the aligned sets of first and second openings to lock the pivotal backshell assembly in a selected angular position, the locking hub being held within the openings by a snap-fit connection.
